(19) United States
(12) Patent Application Publication
(10) Pub. No.: US 2006/0026036 A1
(43) Pub. Date: Feb. 2, 2006

(54) System and method for simultaneously optimizing the quality of life and controlling health care costs

(76) Inventor: Syyed Tariq Mahmood, Los Angeles, CA (US)

Correspondence Address: CHRISTIE, PARKER & HALE, LLP, PO BOX 7068, PASADENA, CA, 91109-7068, US

(21) Appl. No.: 10/909,133

(22) Filed: Jul. 30, 2004

(51) Int. Cl. G06Q 10/00

(52) U.S. Cl. 705/2; 705/4; 703/2

(57) ABSTRACT

A method and system for optimizing health expenditure by an organization including developing a Cohort-based personnel model for the organization; determining lifecycle health costs based on the personnel model; evaluating impact of a lifestyle program, a best health practices program, and an employee benefits program on the life cycle health costs for a first scenario; and measuring project evaluation criteria for the lifestyle, best health practices, and employee benefits programs. A method and system for integrating health and wealth of an individual including developing a profile regarding health and wealth, and quality of life specifications for the individual; determining a quality of life index based on wealth, best health practices and lifestyle of the individual, wherein the quality of life index includes both health and wealth information; and measuring impacts of the profile, wealth, best health practices and lifestyle of the individual on the quality of life index.

### FIELD OF THE INVENTION

The present invention relates generally to computer software; and more particularly to a system and method for integrating health, wealth, and human capital.

### BACKGROUND OF THE INVENTION

For many organizations, health care benefits costs have been increasing sometimes at a double-digit rate. For example, in 2002, health care expenditures in the U.S. were 14.9% of GDP, and the average American spent $5,440 on health care in 2002, with no end in sight to the growth of health care costs. Business health insurance premiums in the U.S. increased by 13.9% on the average in 2003 and obviously for chronologically older companies the growth rate was higher as they have a larger percentage of retirees, and health care expenditures increase with age. (“Trends-Health Spending Rebound Continues in 2002”, Katharine Levit (et al) Health Affairs-Volume 23, Number 1). As a recent survey of health care “The Health of Nations—A Survey of Health-Care Finance” in the Economist of Jul. 17, 2004 makes clear the issues are international.

At the same time, extensive health studies have shown that according to the American Medical Association obesity contributes to approximately 300,000 premature deaths, and added approximately $117B in medical costs in 2000. (Assessment & Management of Adult Obesity, 2003). The consequences for productivity losses to businesses and higher health care costs are obvious, as well as the loss of competitive advantage to companies whose labor forces have these problems to a lesser extent or are directly subsidized by their governments to a greater degree. When one adds the consequences of cigarette smoking with thousands of premature deaths, substance abuse, and preventable back problems, insufficient health screening resulting in diseases that could have been prevented or detected earlier, etc., critical factors impacting organizations both strategically and tactically result. At the same time, some studies have shown that about 70% of physician visits are psychosomatic, which does not mean that they are not necessary, for they can assist in screening for more serious issues, but with useful training some of them can be avoided and substituted for visits focused on prevention. The need for a program that can assist in enhancing the quality of life of individuals in these organizations and at the same time, assist in controlling their health care costs is clear.

In response, many organizations institute wellness programs that exhort individuals in companies to lose weight, follow through with cost effective preventive measures like health screenings, etc., with varying degrees of success. While these programs have achieved some successes, considerable progress still needs to be made to assist organizations and individuals in reducing many of these health liabilities.

Similarly, people either do not save enough for retirement, or they do not save efficiently. The former means the difference between people's desires on retirement, and saving efficiency means the extent to which they do not utilize sound proven savings policies consistent with generally accepted standards. Examples of such inefficient savings include, not sufficiently diversifying portfolios, not picking portfolios that are consistent with long-term objectives, and most importantly, not utilizing the advantages afforded by companies' Individual Retirement Accounts (IRAs) and 401Ks maximally.

For over fifty years sound mathematical models have been developed that provide direction to individuals and organizations on how to best save their money and grow their wealth. These models include the work of Harry M. Markowitz, William F. Sharpe as well as, the work of Stephen A. Ross (Markowitz, Harry M. (1952) “Portfolio Selection.” Journal of Finance 7, no. 1 (March 1952): 77-91; Markowitz, Harry M. (1959) Portfolio Selection: Efficient Diversification of Investments. 1959. Reprint. 1970; Ross, Stephen A. (1976) “The Arbitrage Theory of Capital Asset Pricing”, 1976, Journal of Economic Theory; and Sharp, William F. (1963) “A Simplified Model for Portfolio Analysis,” Management Science, Vol. 9, No. 2, January 1963, pp. 277-293). This work has given rise to what is referred to as Modern Portfolio Theory (MPT), the Capital Asset Pricing Model, and Arbitrage Pricing Theory and has been considerably elaborated since. MPT typically focuses on determining the optimal mix of consumption and investment that should be selected by an individual consistent with time valuation of money and associated appetite for risk. However, while consumption and the accumulation of wealth have received considerable focus in these models, the health of the individual as an asset that allows these other activities to be pursued has not received much attention in them, and if so, not in a practical manner. Typically, MPT emphasis is on providing guidance on the choice of financial instruments that should be selected. MPT provides recommendations on diversification strategies to reduce risk for given levels of returns sought, or conversely, to maximize return for given levels of risk. The concept of mean variance analysis representing return and risk is an important consideration in MPT and is typically represented by the expectation and variance associated with a bundle of investments. There are a number of patents in the field of individual financial planning, for example, U.S. Pat. No. No. 5,784,696, describes a portfolio selector for selecting an investment portfolio from a library of assets based on investment risk and risk-adjusted return; and U.S. Pat. No. 6,484,152, describes a method of automatically selecting a securities portfolio from a number of securities and selecting investment characteristics and investment limits. However, the above-mentioned patents do not integrate the health of the individual as an asset to be also maximized along with his or her wealth.

Therefore, there is a need for a method and system to integrate human capital and wealth into a mathematical model. There is also a need for development of a new class of products that integrate financial planning with health and education planning, and show the financial and health benefits that accrue to individuals as a consequence.

### SUMMARY OF THE INVENTION

In one embodiment, the present invention is a method and system for optimizing health expenditure by an organization. The invention comprises developing a Cohort-based personnel model for the organization; determining lifecycle health costs based on the personnel model; evaluating impact of a lifestyle program, a best health practices program, and an employee benefits program on the life cycle health costs for a first scenario; and measuring a project evaluation criterion for the lifestyle, best health practices, and employee benefits programs.

In one embodiment, the present invention includes optimizing investments by the organization for lifestyle, best health practices, and employee benefits program. Also, different scenarios may be tried by the organization user for achieving the optimized investments. In one embodiment, developing the personnel model for the organization comprises developing an organizational Cohort population model including Cohorts based on age, occupation, seniority, and job hierarchy. Then based on different organizational programs, including benefits programs, best health practices, programs, and healthy lifestyle enhancement programs, and their impact on aggregate organizational lifecycle costs, alternate measures of project evaluation such as return on investment, internal rate of return, return on assets, return on equity, etc., are utilized to optimize allocation of resources.

In one embodiment, the present invention is a method and system for integrating health and wealth of an individual. The invention comprises developing a profile for the individual including current lifestyle, current health practices, and financial information of the individual; determining a quality of life index for the individual based on wealth, best health practices and lifestyle of the individual, wherein the quality of life index includes both health and wealth information about the individual; measuring impacts of the profile, wealth, best health practices and lifestyle of the individual on the quality of life index.

In one embodiment, the invention further comprising making changes in the lifestyle, the current health practices, and the wealth information to improve the quality of life index. The invention also optimizes the quality of life index responsive to selected lifestyle, best health practices, and employee benefits programs. The optimization utilizes changes in the lifestyle index, best health practices, the savings rate and other measures to enhance the quality of life of the individual.

These and other benefits of the inventions are disclosed in the following descriptions in which exemplified embodiments of the inventions are described with respect to the accompanying drawings.

### BRIEF DESCRIPTION OF THE DRAWINGS

FIG. 1 shows major elements of MODEL 1.0 and MODEL 2.0 integration embodiments, according to one embodiment of the invention;

FIG. 2 shows a unit of analysis utilized in the development of the Optimal Investment Criteria in Health Expenditures;

FIG. 3 depicts an overview of main modules in the Optimal Investment Criteria in Health Expenditures Model, and procedural steps required to calculate appropriate values in each, according to one embodiment of the invention;

FIG. 4 illustrates a detailed flow diagram for MODEL 1.0 embodiment, Optimal Investment Criteria in Health Expenditures for Organizations;

FIG. 5 shows examples of different complexities in determining health benefits costs in organizations;

FIG. 6 shows an example for developing Cohorts from organizational databases and development of aggregate lifecycle health costs for organizations;

FIG. 7 depicts impact of changes in health benefits, and prevention programs for an organization's health care costs;

FIG. 8 shows key components of quality of life in terms of values, health, wealth and education and learning, according to one embodiment of the invention;

FIG. 9 shows an example of an objective function for quality of life, according to one embodiment of the invention;

FIG. 10 is an exemplary graphic illustration of how people typically spend their money on health when it is their own money;

FIGS. 11A and 11B depict examples of contents of the MODEL 2.0 DVD, data and videos;

FIG. 12 illustrates a sample of MODEL 2.0 user interface for online connections;

FIG. 13 shows a sample screen for user Profile integrating health, finance, organization benefits, and utility trade-offs;

FIG. 14 shows a sample screen for finance component of the Quality of Life (QOL) specifications;

FIG. 15 depicts a sample screen for Lifestyle Choice Inputs for the Quality of Life (QOL) specifications;

FIG. 16 shows a sample screen for Best Health Practices for Quality of Life (QOL) specifications;

FIG. 17 shows a sample screen for QOL optimization;

FIG. 18 depicts interactions between the user and different hardware/software/communications combinations;

FIG. 19 shows an example of a simple DVD implementation;

FIG. 20 illustrates an integration of the different environments to meet the needs of people with different settings and skill sets, according to one embodiment of the invention;

FIG. 21 shows an example of how the customized newsletter interacts with the individual profile and organization sites, according to one embodiment of the invention;

FIG. 22 illustrates a PC-DVD Internet configuration for video, according to one embodiment of the invention;

FIG. 23 illustrates a Kiosk configuration, according to one embodiment of the invention; and

FIG. 24 illustrates a Web centric configuration, according to one embodiment of the invention.

### DETAILED DESCRIPTION OF THE INVENTION

The present invention relates to two critical areas related to optimizing the quality of life of people (e.g., employees, family members, and retirees) associated with organizations (e.g., government, for profit, and non-profit) and individuals either alone, in associations with, or customers of organizations (e.g., an insurance company). In one embodiment, in a macro level, the present invention utilizes a computer software for determining how much resources should be allocated to health expenditures for the employees, family members, and retirees of organizations, and what percentage of it should be allocated to various prevention programs that attempt to improve the quality of life of the individual, and thus controlling the growth of health care costs.

In another embodiment, at the individual level, the software of the present invention is directed to allowing individuals to determine the optimal lifestyle, and Best Health Practices choices that will enhance the quality of their lives, based on their values. Included in this embodiment are novel mathematical models that extend the scope of MPT beyond financial issues.

While considerable elaborations of MPT are known, the present invention integrates health, human capital and the objectives of MPT into one comprehensive model, and allows individuals to maximize each. In addition, the invention includes unique procedures that allow individuals to simulate improvements in their health and financial situations as they improve their lifestyles, their Best Health Practices, and/or their financial strategies.

As an example, if an individual reduces his smoking from two packs to one pack a day, there is a financial impact which, at a minimum, is represented by increased income and wealth associated with the money saved from purchasing one less pack of cigarettes and enhanced work-related performance. Another impact is on reduced incidence of heart disease, cancer, and other areas that result in increased quality of life years. MPT can only model the first impact, not the second and thus under-represents the value of reducing smoking. This integration of health and wealth sensitizes individuals and organizations to the important need for integration of these issues. It also directly leads to programs that provide individuals with critically important information for their unique situations, developing clear implementation programs in improving the quality of their lives, and controlling health care costs through prevention. As a result, this integration of health and wealth makes possible and flourishes the development of a new class of products and services that integrate all or subsets of health planning, financial planning, and education planning.

While the units for consumption are, as usual, denominated in money, the health component is represented by QALY, or Quality Adjusted Life Years, that is, a common measure of health. A QALY of 70 means seventy years of life without any major illness, while an individual who is bedridden for 6 months before death at 70 may allocate 69.5 to his or her QALY. The measure of the discomfort and its implications on QALY is based on individual preferences. QALY is utilized within this context throughout the document.

In one embodiment, the present invention is directed to a method and system, at a macro level, for organizations (governments, for-profit, and not-profit, etc.) for determining their total health liabilities from current employees, family members, and retirees, determining outcomes associated with various health policies and calculating resulting program evaluation (e.g., Returns on Investment, Internal Rate of Return, Return on Assets, Return on Equity, etc.) from the resources allocated. In another embodiment, the present invention is directed to a method and system embodying mathematical models for individuals associated with these organizations, for maximizing the quality of their lives in terms of health, wealth, and education and providing focused information to select lifestyles and Best Health Practices to support the endeavor at the micro level. There are a number of areas of focus for this optimization of quality of life, for example, people could always allocate their savings more efficiently. The optimization of quality of life also provides individuals with opportunities for healthier lives and as a consequence, aggregated lifecycle health costs are better controlled for organizations. The macro level organizational embodiment is referred to as the MODEL 1.0 embodiment for organizations, while the second embodiment including the mathematical models focused at individuals is referred to as the MODEL 2.0 embodiment. In yet another embodiment, MODEL 1.0 and MODEL 2.0 embodiments are integrated together for a complete analysis of health, wealth, and other factors of organizations and individuals. This is referred to as the Invisible Hand Principal for Health Expenditures.

Typically, there are two sets of issues that organizations face when attempting to control health care costs. At the macro level, they have to determine how much resources should be allocated for health requirements of their employees, their covered family members, and retirees, given their long run objectives and legal obligations. The second macro level issue relates to understanding what percentage of this expenditure should be allocated to programs that assist the same individuals in improving the quality of their lives (in terms of health, this would mean healthier lifestyles and Best Health Practices) and thus controlling some of the health liabilities that result.

Thus, MODEL 1.0 embodiment for organizations assists companies in developing standard return on investment indicators for programs that address both sets of macro issues. In order for such programs to be effective, individuals associated with these organizations and others have to be motivated and trained. Also, follow up measures have to be integrated to assist the individuals in making important critical choices for themselves. MODEL 2.0 embodiment utilizes MPT as a point of departure, and creates a new class of models in which MPT, the Capital Asset Pricing Model (CAPM) and Arbitrage Pricing Theory (APT) are special cases, when applied to individuals. Therefore, inconsistencies between an individual's concern for his or her wealth and health are dissipated. For example, someone maybe taking care of his retirement portfolio very well and has accumulated over a million dollars, however, he dies at the age 55 because he has been smoking and has been 50 lbs overweight. MPT, CAPM, and APT are only focused on assisting this individual in managing his savings efficiently consistent with his time value of money and his propensity for risk. At the same time, independently different wellness programs are focused on the health areas through exhortation and benefits choices. When the two areas are integrated into the software of the present invention through an integrated mathematical model, it may make more sense for a specific individual to lose 30 lbs. of weight (with vastly diminished risk of diabetes, heart problems, etc. and increased work productivity) than to attempt an extra percentage return on his retirement portfolio within his own perceived values. Such analysis is not possible with the class of financial models cited above.

The method and system of the present invention simultaneously optimize the quality of life of people and control health care costs through prevention. In one embodiment, the system and method of the present invention have two major building blocks. The first one is a macro level model referred to as MODEL 1.0 embodiment for determining the optimal level of health expenditures for employees, their covered family members and retirees along with the percentage of these that should be allocated to programs to promote their quality of life based on the long run strategic goals of the organization. The second model, a micro level model referred to as MODEL 2.0 embodiment, assists individuals working in these organizations, their covered family members, or retirees and even self-employed individuals to determine the optimal choices to enhance the quality of their lives consistent with their personal values.

As described in more detail below, MODEL 1.0 and MODEL 2.0 embodiments lead to mutually beneficial and integrated goals in terms of determining the optimal mix of direct and indirect health expenditures consistent with long run organizational goals, and at the same time allowing individuals associated with these organizations to optimize allocations consistent with their individual resource endowments that enhance the quality of their lives. This organizational allocative efficiency also results in individual benefits to quality of life efficiencies. In other words, the organizations experience a healthier and more productive work force with control over health costs. Also, individuals can plan their retirements and every day lives by making appropriate decisions on improvement in the quality of their lives.

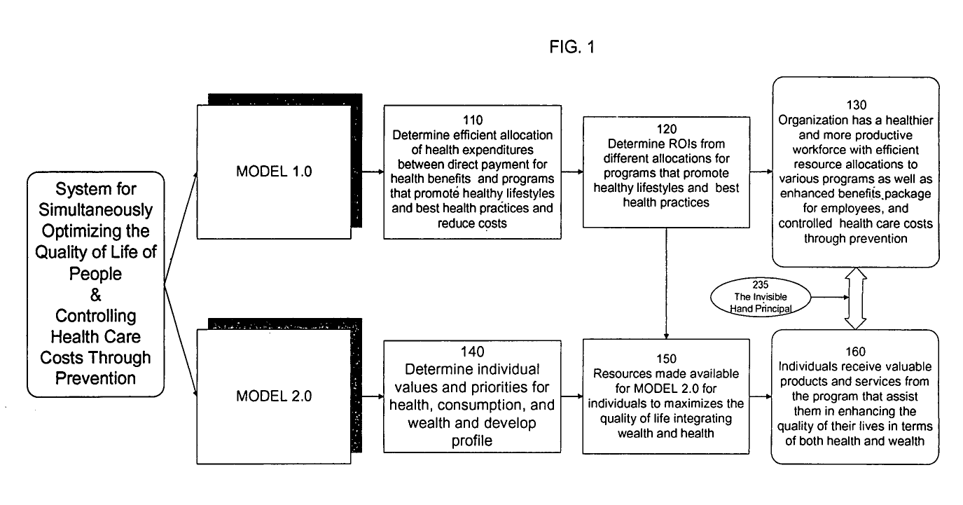

FIG. 1 shows an example of how these two components, MODEL 1.0 and MODEL 2.0 are integrated in one embodiment of the present invention. Model 1.0 embodiments focus on the steps required to determine program valuations from various bundles of benefits, investments in lifestyle, Best Health Practices programs, and the resulting reductions in health care costs. MODEL 2.0 embodiments focus on enhancements to lifestyles, Best Health Practices as well as, savings strategies that are focused on enhancing the quality of life for participating individuals.

In one embodiment, MODEL 1.0 includes the following generalized steps:
Develop an organizational personnel model (for an organization, its employees and retirees, and their families), over a projected time period determined by the organization,
Develop life cycle health costs based on the personnel model,
Evaluate impact of different programs (Lifestyle, Best Health Practices, and employee benefits) on the developed life cycle health cost,
Evaluate the overall benefits to the organization
Measure each scenario, benefits derived and associated costs utilizing different measures such as Return on Investment, Internal Rate of Return, Return on Assets, Return on Equity, and any other accepted methodologies.

As shown in FIG. 1, module 110 determines efficient allocation of health expenditures between direct payment for health benefits and programs that promote healthy lifestyles and Best Health Practices and reduce costs. Module 110 focuses on establishing the objectives of the model in terms of determining the amount of expenditures that should be allocated to health by organizations consistent with their missions. There is also a related question on the percentage of these expenditures that should be allocated to quality of life programs.

Based on the response to the above question, module 120 calculates program valuations for different expenditures on quality of life programs for individuals. Other variations of project appraisal such as, net present value, internal rate of return, etc., can also be utilized consistent with organization policies. These results are output into module 130 as benefits accruing to the organization as well as, to module 150 for expenditures for quality of life decisions by individuals associated with the organization.

Module 130 describes the various benefits derived by organizations. These include as examples, a more productive workforce, more efficient resource allocations to different programs, an enhanced benefits package in terms of value for employees, and controlling of health care costs through prevention.

While MODEL 1.0 embodiments focus on the organization, MODEL 2.0 embodiments focus on the individual, in this case, associated with the organization. MODEL 2.0 embodiments can also be utilized by self-employed or independent individuals, in which case the resources for the model are independently derived.

MODEL 2.0 embodiments focus on optimizing the quality of life of individuals when they are affiliated with organizations (employees, family members and retirees), or are independent. In one embodiment, MODEL 2.0 includes the following general steps:
Develop a profile for the individual including the individual's value system including current lifestyle, current health practices, and financial information,
Measure impact of developed profile on a quality of life index including consumption, wealth, health, and education, and
Make changes in the current lifestyle, the current health practices, and the financial information to improve quality of life index.

The economics of the program determine the level of investment in MODEL 2.0 when done in association with organizations (employees, covered dependents, and retirees). In other instances MODEL 2.0 can stand alone and are determined by individual choice.

In module 140, individual's values and priorities for health, consumption, and wealth are determined (e.g., by answering some questions by the individual) and a profile for the individual is developed. This integrates health information such as gender, age, weight, state of current health, family predispositions to various diseases, a lifestyle questionnaire in terms of diet, nutrition, exercise levels, etc., and a Best Health Practices questionnaire on cost effective health screenings practiced consistent with age, gender, and family predispositions. Once the profile database for the individual and family is developed it has a wide array of uses. The profile can be communicated in various formats to one's personal physician. The systematic library of data collected can alert a family member in a family that has implications for others, and any other uses that may arise. Different information may be targeted via emails or other means of electronic distribution to particular individuals determined by the profile.

The invention also integrates wealth and income information related to current income from all sources, and wealth controlled in various categories. Human capital in terms of education and other skills is also included. Finally, the relative preferences for different relationships between individual choices and between health, income, wealth and human capital, including different levels of acceptable risk are determined. In module 150, resources are made available to MODEL 2.0 for individuals which then maximizes the quality of life integrating wealth and health.

Module 150 refers to mathematical models that utilize the profile from module 140 to develop optimal choices for the individual, consistent with his or her preferences, and to develop resource endowments in terms of his or her quality of life encompassing, health, wealth, and education.

Module 160 is capable of generating valuable products and services such as newsletters, DVD, information posted on websites, and the like from the program that assists individuals in enhancing the quality of their lives in terms of both health and wealth.

Module 160 refers to efficiencies derived from the program such as potentially longer and higher quality lives, greater wealth and income, as well as ancillary profile based services offered by organizations and vendors. Examples of these services include information on child care services in the region, detailed information and guidance on managing one's health, and wealth consistent with one's profile.

The Invisible Hand Principal for Health Expenditures 235, shown in FIG. 1 refers to the process by which organizational choices developed are consistent with individual choices made and result in the enhancements to the quality of life of individuals as well as controlling health care costs through prevention for the organization.

An exemplary embodiment for MODEL 1.0 that generates optimal investment criteria for health expenditures in organizations is now described. Clearly, organizations maintain different levels of commitments to maintaining a healthy workforce, and also provide health benefits to their covered family members, and to appropriately determined retirees based on years of service and other criteria. The issue is to determine the optimal level of such expenditures is, and the proportion that should be in direct health benefits outlays, with other areas focused on programs that assist people in being healthier and thus consuming less health dollars.

In this embodiment, the invention minimizes the present value of the lifecycle health costs of employees, their family members, and retirees consistent with long run organizational objectives (e.g., profit maximization, organizational mission for non-profits, and governmental objectives for appropriate government entities)

In practice, this means that the health care objectives of an organizations tend to be:
1) A healthy work force (highly Productive-alert; reduced at work morbidity, low absence rates);
2) Safety net in case of emergencies or unforeseen diseases for employees, their covered families, and retirees consistent with internal organizational values and competitive structures; and
3) A minimized present value of lifecycle healthcare costs of employees, their covered family members, and retirees (Direct health costs, Workman's Compensation, Disability, Employment Assistance Programs) such as unnecessary physician visits, hospitalizations, preventable diseases, or screening for diseases earlier.

Organizations typically have two broad categories of choices on how they attempt to achieve these objectives. The first category includes direct payments or co-payments for health expenses of employees, their covered family members, and retirees. The second category includes expenditures on programs that facilitate employees, their covered family members, and retirees to enhance the quality of their lives, both in terms of health (healthier lifestyles, Best Health Practices) and wealth (better management of their savings, and better utilization of company financial benefits like the IRA and the 401K).

The determination of the optimal mix between the two categories is an important strategic question for organizations. For individuals that are involved with these organizations, there are many different health and financial planning issues that are not being addressed in satisfactory manner.

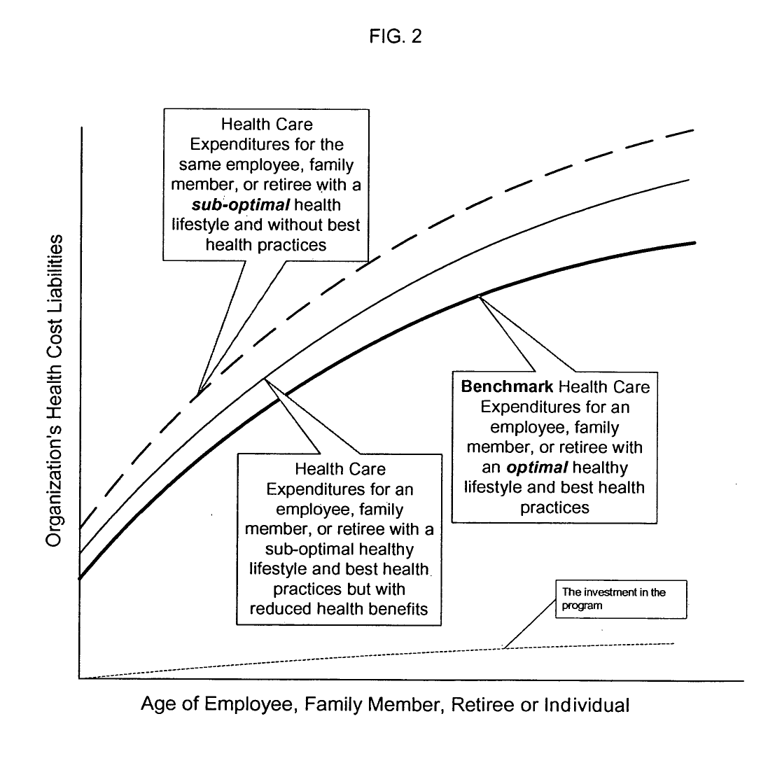

FIG. 2 shows a fundamental unit of analysis utilized in the development of the Optimal Investment Criteria in Health Expenditures Model. The focus is on the individuals in the organization, whether they are employees, covered family members, or retirees, as the health benefits liabilities of organizations originate there.

As shown in FIG. 2, any individual has an impact on the health benefits costs for an organization. These costs increase with age as depicted in the graph of FIG. 2. As an example, four trajectories are presented. The first one is the case of the health costs generated by an individual in any of these three categories (employees, covered dependents, and retirees) not following a healthy lifestyle, and not observing Best Health Practices but having excellent benefits. The second trajectory is that of the same individual with lowered health benefits but no changes in lifestyle or Best Health Practices. The third trajectory is that of the same individual after she follows an optimally health lifestyle and Best Health Practices. However, there are varying degrees to this case. Accordingly, a lifestyle index, and a Best Health Practices index that captures the variety of possibilities here are developed. The fourth trajectory is associated with the investment in the quality of life program.

In all of the above-mentioned first three trajectories, the present value of the health costs for each trajectory is referred to as the present value of the lifecycle health costs for the individual. The start time is the date of hire if covered by health benefits and the end date is when health benefits cease; either because the individual is not associated with the company and does not carry over any health benefits, or the date of the last benefit paid either due to death or other causes. The fourth trajectory is the investment associated with the program.

FIG. 2 conceptually presents the total organization health care liabilities for an individual who follows an optimally healthy lifestyle and Best Health Practices, and the total organization health care expenditures for the same individual if he or she does not optimize on either or both. By altering health benefits, these liabilities can be reduced as in the middle trajectory. Here, the difference between the highest and the third highest trajectories represents the opportunity set for the present inventions, that is, representing potential cost savings. Organizations make investments in technology tools, and other services to reduce the differential between the two trajectories thereby reducing organization health care expenditures and also improving the quality of life of the individuals involved. The dashed line at the bottom represents the investment in the program of the present invention. However, by subscribing to an HMO, companies do not escape these issues, as their health premiums are in turn affected by the same underlying factors.

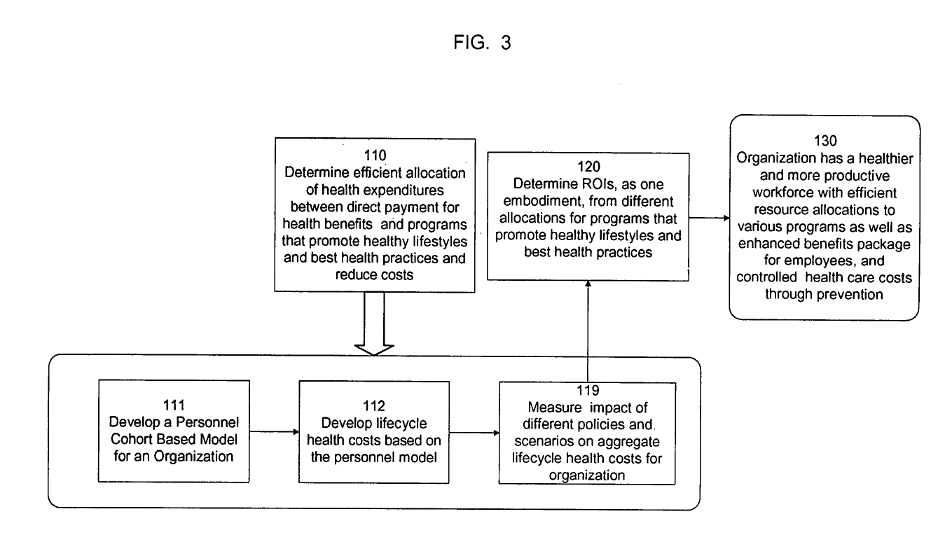

FIG. 3 provides an overview of three main modules in MODEL 1.0 and the general steps to calculate appropriate values in each, according to one embodiment of the invention. As shown, module 110 (from FIG. 1) is decomposed into three blocks, before reconnecting to module 120 in FIG. 1.

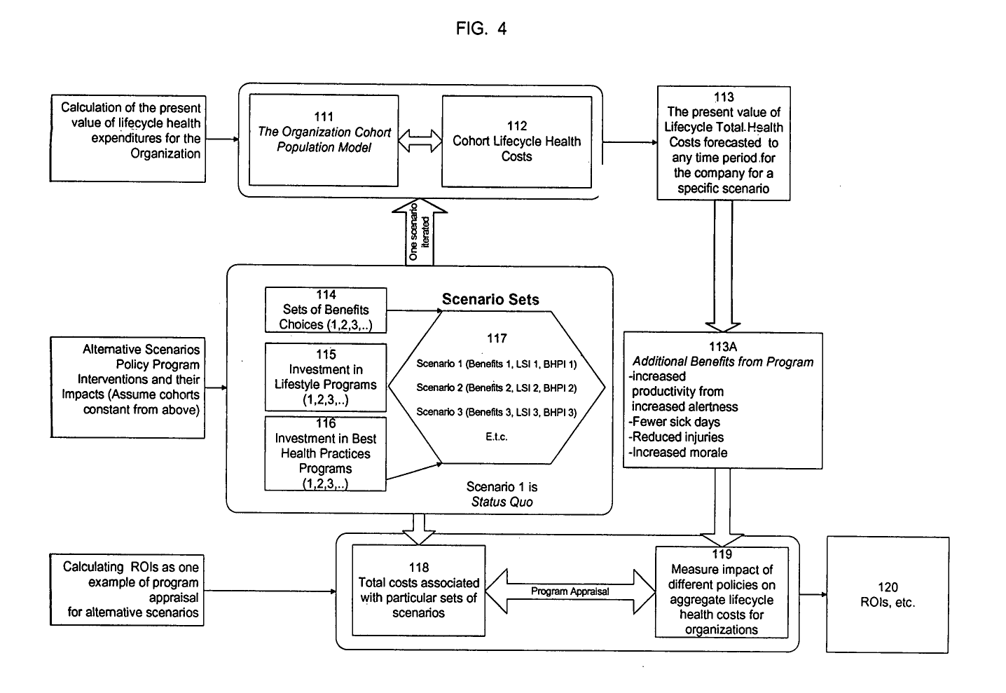

In block 111 of FIG. 3, the Personnel Cohort-based model for an organization is developed and also utilized in FIG. 4. Several Cohorts, one for each category of employees (their family, dependent, and retirees) such as, age category, seniority, etc. are included as one embodiment in the Personnel Cohort model. In block 112, the lifecycle health costs for each Cohort is developed based on the Cohort model for an organization. In block 119, combinations of alternative health benefits, different expenditure levels on programs geared to incentives for enhancing individual lifestyles and Best Health Practices are selected and impact of different policies on aggregate lifestyle health costs for the organization is measured using computer simulation for different scenarios. Each of these program expenditures reduce lifecycle health costs consistent with FIG. 2. Given these aggregated organizational lifecycle health cost reductions (treated as program benefits), costs are associated as investments in these programs. Based on these costs and associated benefits, different measures such as, returns on investments are determined in block 120.

The challenge is to determine the optimal level of such expenditures and the proportion for direct health benefits outlays, with other areas focused on programs that assist people in being healthier and thus consuming less health dollars.

FIG. 4 illustrates a more detailed flow diagram for MODEL 1.0 embodiment. In FIG. 4, the top section provides details for the first element of the MODEL 1.0 embodiment, that is, calculation of the present value of lifecycle health expenditures for the organization. In block 111, the organizational Cohort population model includes Cohorts based on age, occupation, seniority, and job hierarchy along with the mean number of covered dependents from personnel files in an organization. Covered retiree information can be gleaned from benefits departments. The model integrates new entrants into the company, people leaving, retiring, dying, new births among dependents, new dependents by marriage, etc.

The invention treats a company's employees, their covered family members, and retirees as a demographic population. Besides the usual births, deaths, and morbidity indicators, the invention considers downsizing which is treated similar to out-migration. Growth of employment is treated as in-migration or immigration by age, gender, occupation, and hierarchy categories. Ethnic breakdowns, occupation and hierarchy categories are utilized. Besides, tracking individual chronological age, hire date allows the invention to calculate seniority of the employees. The organizational cohort population model can also be configured for additional variables besides the ones specified here consistent with organizational priorities and situations.

The invention then associates different benefits packages to each Cohort category as defined above. Then, just as in a population, each Cohort is tracked in terms of death, emigration, immigration, new hires, coverage of dependents and their emigration and immigration (children not covered after a certain age, new births, older children by marriage, divorces, marriages, etc.). The employees that retire with full benefits and their ongoing dependents (spouses, significant others) are tracked to their end of life as Cohorts.

This yields a corporate population model, which includes employees, their covered family members and retirees, with Cohorts described by age, gender, seniority, occupation and hierarchy, and their health benefits choices within each of the three categories, resulting in a matrix of six dimensions for each of the three groups. A separate module categorizes, health care costs by different categories and projects their rate of growth over time.

Multiplying the corporate Cohort population model by the health benefits matrix yields total health costs for a corporation, carried out to any specified time period. Organizations input relevant information about their companies to develop the corporate Cohort population model, the health benefits matrix, and the various scenarios. In other words, the total cost for the organization is the total health benefit costs plus total investment in Best Health Practices program and the Lifestyle program.

In block 112, the different health benefits offerings for each Cohort are specified and based on assumptions, they are projected out for any required number of years. In block 113, the results of blocks 111 and 112 are captured in a present value of the organization's lifecycle health benefits costs projected out to the year n. This represents the base case for the rest of the analysis. Block 113A integrates additional benefits from the program including increased productivity, fewer sick days, a reduced injury rate, and increased morale. In block 119, the total benefits of the program from the different policies are accumulated and different scenarios (discussed below) are presented in an array with each element of the array associated with a particular scenario. For example, scenario 1 maybe the status quo case or the initial set of conditions in the organization.

The middle section of FIG. 4 represents the development of alternative scenarios and their associated costs as inputs into the section above for calculation of benefits. Different scenarios on the health profile of on organization's populations with different forms of intervention (e.g., different prevention programs, training and sensitizing of new hires, existing employees, various technology tools, etc.) and the impact of different benefits programs, etc. yield different health liabilities, when changes in lifestyles and Best Health Practices are simulated, according to these scenarios. Based on these differences in health liabilities from these intervention programs and the investment made in these programs, different financial indicators such as, ROI are calculated from the investments made.

Accordingly, this embodiment of the present invention elaborates on different scenarios associated with different benefits changes, and various expenditures on prevention measures. Each scenario is a set of organization's benefits choices 114, investments in lifestyle programs 115, and investments in Best Health Practices 116. In scenario set of 117, the existing conditions or status quo are labeled as scenario 1 and alternatives are considered as Scenario 2, and Scenario 3. Each scenario has costs attributed to it, which flow into block 118. Each scenario also has benefits flowing through block 112 into block 113. The additional benefits from increased productivity of the workforce, increased alertness, fewer sick days, etc., are then integrated. The result is utilized to measure the aggregate benefits arising from scenario 1 to scenario 2, etc., as shown in block 119. Benefits 1 is an array of organization's existing health benefits, LSI (Lifestyle Investment) 1 is the existing investment in enhancing Lifestyle Programs while BHPI 1 represents Best Health Practices by the organization, and other numbers are different scenarios utilized.

Block 114 integrates the sets of benefits choices offered by the organization for different Cohorts. These include, for example, choice of HMO, private physicians, insurance coverage type and amount, etc. The sets of benefits choices need not be different between one scenario and the next. Block 115 represents the investment in programs geared to enhancing healthy lifestyles by the organization for different Cohorts. These investments may include weight loss programs, quitting smoking programs, etc. that the organization is providing (or reimbursing) the individuals.

Block 116 represents the investment in programs to enhance Best Health Practices by the organization for different Cohorts. These may include cost effective health screenings and physical check ups, for example. A group of scenario sets are presented in block 117. Each scenario integrates one array of benefits choices from block 114, one array of investments in lifestyle programs, and one array of investments in Best Health Practices. Each array does not need to be unique between one scenario and the next, as the scenario may determine changes from say lifestyle programs alone while holding everything else constant. Block 118 accumulates the total costs associated with each scenario from benefits choices, investments in lifestyle programs, and investments in Best Health Practices programs.

The bottom section of FIG. 4 integrates the total costs associated with the different scenarios in block 118 with the total benefits derived for the same set of scenarios to develop various project evaluation criteria. For example, one or more of Return on Investment, Internal Rate of Return, Return on Assets, Net Present Value, and any other methodology that is appropriate for such analysis including stochastic simulations, are calculated.

Block 120 captures these various calculations of project appraisal, based on blocks 118 and 119. In block 120, based on different levels of expenditures on prevention measures and benefits, ROIs on the prevention measures are calculated based on expected declines in health costs attributable to these prevention measures. These ROIs are determined from different allocations for programs that promote healthy lifestyles and Best Health Practices and the scenario with the best evaluations determines optimal investment criteria in health expenditures.

Various optimization algorithms can be utilized to determine the best sets of benefits choices, investments in lifestyle programs, and investments in Best Health Practices consistent with various actuarial studies on the expected impact of these scenarios on organizational health and associated health costs. After this optimization is implemented, a business decision is made for the most appropriate choices. The embodiments of the present invention utilize any or a range of different program valuation measures, including but not limited to, benefit/cost analysis, Return on Investment, Internal Rate of Return, Net Present Value to rank the impacts of alternative scenarios and select the most appropriate one from an organization's perspective.

No one optimization algorithm is appropriate for all organizations. For instance, in a MODEL 1.0 embodiment, different algorithms may be developed that take different elements from health benefits alternatives, different health lifestyle expenditures, and programs that enhance Best Health Practices as scenarios, and test them against actuarial tables to determine project evaluation returns utilizing different measures. As each scenario is tested, different project evaluation criteria are calculated until a solution is found that provides the highest rate of return. Examples of such algorithms, without limitations, include linear and non-linear programming, heuristic algorithms such as the hill climbing algorithms, and optimization schema such as the Pontryagin Maximum Principal, the Method of Lagrange, etc. The choice of the methodology employed will be contingent on the organizational mission, and the quality and quantity of data available.

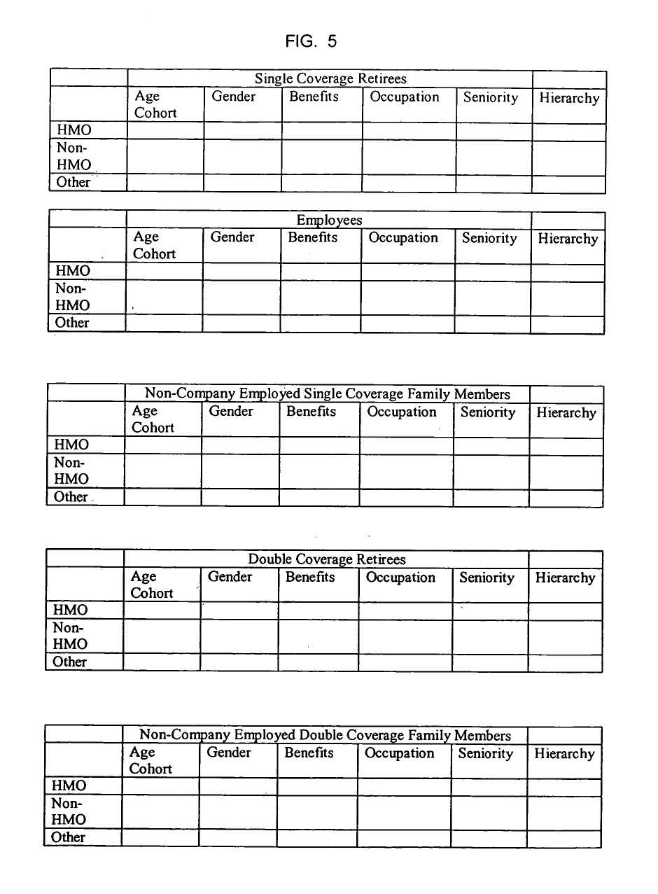

There are many complexities that arise in the various combinations of health benefits that are paid out to employees, their covered family members and retirees. FIG. 5 portrays examples of these complexities and some of the variables to define Cohorts.

In one embodiment, the Cohorts form a 6-dimension matrix, an example of which is shown below in equation (1). (The definitions can be modified for any particular organization). Some of these matrix dimensions will not be as relevant for some industries, companies, or non-profit and government entities.

$$( \begin{matrix}{A}_{11} & … & {A}_{1 n} \\ ⋮ & ⋰ & ⋮ \\ {A}_{m1} & … & {A}_{mn}\end{matrix} ) \qquad ( 1 )$$

Here, assume that the columns represent age Cohorts and they can be say (18-25), (25-35), (35-45), (45-55), etc., or simply n categories.

The rows represent, for example, hierarchy levels associated with the Cohort (e.g. grade 11, grade 18). So, the Cohort description in this instance represents m hierarchies. In a similar manner, the 6-dimension matrix can be described by two dimensional representations. The set of all such unique representations defines the 6-dimension matrix.

While covered dependents can be treated independently, the simpler approach is to ascribe an average dependents number to each Cohort for the purpose of this model, covered dependents are treated as an employee, as the benefits plan applies to them as well. This average integrates the dynamics of any dependent changes. For some internal company programs, the average dependents ratio can be dropped, as it does not affect non-employees.

The Cohort undergoes a number of changes over time, such as: people age, some people leave the company, new entrants join the Cohort, some people get promoted, and therefore transition into a different Cohort, similarly during a downsizing, there is also movement within the Cohort, employees die, employees retire, there are changes in their dependents, new spouses arrive or leave, new children are born, or in some instances die, children transition out with age and are no longer covered, new spouses may bring additional children from a previous marriage, etc.

Therefore, the following equation for

$${\sum }_{j = 1 , 4} {a}_{1 j} {b}_{j1}$$

represents the health benefits costs for any given year:

$$( {a}_{11} {a}_{12} {a}_{13} {a}_{14} ) ( \begin{matrix}{b}_{11} \\ {b}_{21} \\ {b}_{31} \\ {b}_{41}\end{matrix} ) = {\sum }_{j = 1 , 4} {a}_{1 j} {b}_{j1} \qquad ( 2 )$$

Where each “a_{1J}” for the particular Cohort represents the numbers of the Cohort 1 and dependents enrolled in health plan “J”, and “b₁₁” represents the annual price of health plan “1” for people in Cohort 1 who selected it. Note, the health plans represented are a comprehensive list, as are the prices for them. This means that if a Cohort is not utilizing a particular plan or it is not available to a plan, the respective terms will be zero.

Cohorts for the organization are defined by the same categories as above in terms of age, gender, occupation, and hierarchy categories. As an example of what is being illustrated, suppose we have a Cohort defined as follow:
Age: 40-45
Sex: Male
Occupation Category: Office Worker
Job Hierarchy: Grade 18
Hire Date: 1995
Average Dependents: 1.5

Then, each of the elements in the A matrix would represent the number of people in the Cohort that have selected health benefits choice 1, 2, 3 and 4 (assuming the company offers four health benefits plans).

For each additional year, the expected growth rate of costs is integrated and an appropriate discount rate for current dollars is utilized. The health costs for each Cohort can now be forecast as follows:

$$( {a}_{11} {a}_{12} {a}_{13} {a}_{14} ) ( \begin{matrix}{b}_{11} & {b}_{12} & \cdot \\ {b}_{21} & {b}_{22} & \cdot \\ {b}_{31} & \cdot & \cdot \\ {b}_{41} & \cdot & {b}_{43}\end{matrix} ) = {\sum }_{j = 1 , 4}^{k = 1 , 3} {a}_{1 j} {b}_{jk} \qquad ( 3 )$$

Where, the second year cost estimates in the B matrix are represented by the second column, and the third year cost estimates are represented by the third column. The new summation thus aggregates the health costs for all three years.

This assumes the Cohort is constant for all three years, as an approximation.
A×B=C (4)

Here, A includes the people in a Cohort categorized by their health benefits choices, with each row representing a different Cohort, as before. Similarly, B is the Lifecycle health costs and includes the costs of benefits normalized by the time value of money with each column representing present to future years. The C matrix represents health expenditure costs associated with all the Cohorts for three time periods.

For example, as one embodiment, assume there are 5 Cohorts with 4 types of health benefits into which they are categorized, and the health costs need to be projected out to n years for all of them. Then, equation (5) represents an example of N period forecast of health expenditures for an organization's employees and dependents:

$$\begin{matrix}( \begin{matrix}{a}_{11} & … & {a}_{14} \\ ⋮ & ⋰ & ⋮ \\ {a}_{51} & … & {a}_{5 , 4}\end{matrix} ) \times ( \begin{matrix}{b}_{11} & {b}_{12} & {b}_{1 n} \\ {b}_{21} & {b}_{22} & \cdot \\ {b}_{31} & \cdot & \cdot \\ {b}_{41} & \cdot & {b}_{4 n}\end{matrix} ) = ( \begin{matrix}{c}_{11} & … & {c}_{1 n} \\ ⋮ & ⋰ & ⋮ \\ {c}_{51} & … & {c}_{5 n}\end{matrix} ) \\ = {\sum }_{i = 1 , 5} {\sum }_{j = 1 , 4}^{k = 1 , n} {a}_{ij} {b}_{jk}\end{matrix} \qquad ( 5 )$$

This methodology is extendable for any dimensions required by the organization. Retirees are treated in separate Cohorts, for implementation purposes as illustrated in equation (5).

The same methodology applies to retirees below as an example of N period forecast of health expenditures with five Cohorts for an organization's retirees:

$$\begin{matrix}( \begin{matrix}{r}_{11} & … & {r}_{14} \\ ⋮ & ⋰ & ⋮ \\ {r}_{51} & … & {r}_{5 , 4}\end{matrix} ) \times ( \begin{matrix}{b}_{11} & {b}_{12} & {b}_{1 n} \\ {b}_{21} & {b}_{22} & \cdot \\ {b}_{31} & \cdot & \cdot \\ {b}_{41} & \cdot & {b}_{4 n}\end{matrix} ) = ( \begin{matrix}{c}_{11}^{′} & … & {c}_{13}^{′} \\ ⋮ & ⋰ & ⋮ \\ {c}_{51}^{′} & … & {c}_{5 n}^{′}\end{matrix} ) \\ = {\sum }_{i = 1 , 5} {\sum }_{j = 1 , 4}^{k = 1 , n} {r}_{ij} {b}_{jk}\end{matrix} \qquad ( 6 )$$

where, the health benefits costs are selected to be consistent with the benefits offered retirees.

The methodology can be readily extended for dynamic Cohorts as follows:

Assume there is one Cohort that changes over time. There are additions as new hires come in, there are deletions as people leave, and there are changes to the Cohort as people age, are promoted, etc. Then, for the case of employees and their dependents and an N period forecast, equation (5) above is represented as:

$$\begin{matrix}( \begin{matrix}{a}_{11} & … & {a}_{14} & {a}_{15} & \cdot & \cdot & {a}_{18} \\ {a}_{21} & & & & & & {a}_{28} \\ & & & & & & \\ {a}_{41} & & {a}_{44} & & & & {a}_{48}\end{matrix} ) \times ( \begin{matrix}{b}_{11} \\ {b}_{21} \\ {b}_{31} \\ {b}_{41} \\ {b}_{51} \\ {b}_{61} \\ {b}_{71} \\ {b}_{81}\end{matrix} ) = ( \begin{matrix}{c}_{11} \\ {c}_{21} \\ {c}_{31} \\ {c}_{41}\end{matrix} ) \\ = {\sum }_{i = 1 , 8 , j = 1 , 8}^{k = 1} {a}_{ij} {b}_{jk}\end{matrix} \qquad ( 7 )$$

Where in equation (7), the first four elements of the first row of the A matrix are the numbers of Cohort 1 receiving the four categories of benefits in time period 1, and the last four are the same Cohort in time period 2. In the second row, the same relationships for the second Cohort are shown, and so on, till all four Cohorts are covered. The benefits matrix has the first four items representing the normalized benefits costs for period one, and the last four representing the normalized benefits for period 2.

Here, there are four Cohorts for two time periods. However, the model can be extended to an arbitrary number of Cohorts with an arbitrary number of periods. The same methodology also applies to retirees.

This methodology is general in that organizations determine the definitions of their Cohorts consistent with their missions and organizational structures. With fast growing young companies, the retiree portion may be insignificant, while for mature industries with losses in market share, it is critical. The generalized methodology is made particular by context.

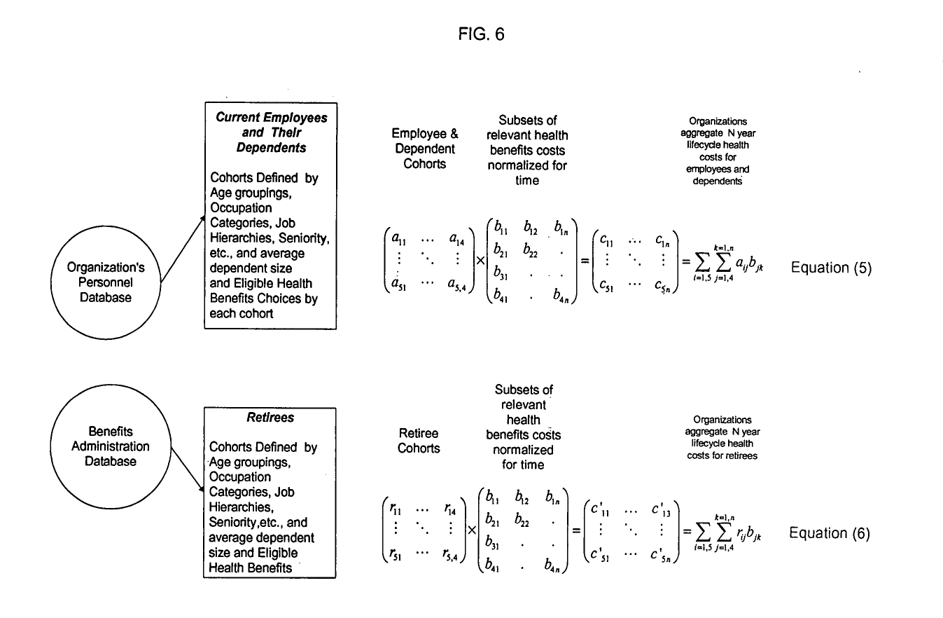

FIG. 6 shows an exemplary process for calculating an organization's health costs for N-Period forecast. FIG. 6 delineates the different modules and procedures for FIG. 4. A computer software, according to one embodiment of the present invention accesses the organization's personnel database and develops the Cohorts consistent with the description above utilizing equation (5) to calculate block 113 utilizing block 111 and 112 of FIG. 4. Similarly, the embodiment described above, develops the Cohorts from the benefits administration database and utilizes equation (6) to calculate the lifecycle health costs for retirees from the present onward, as shown in FIG. 6.

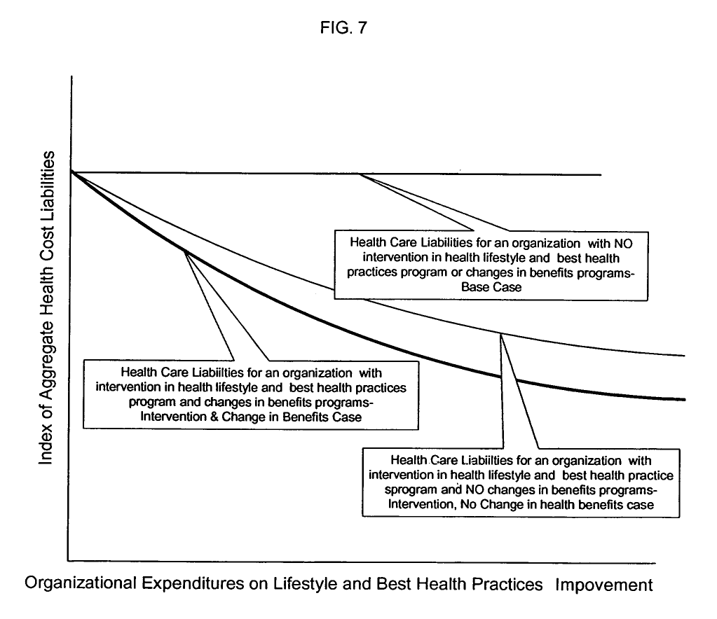

Section 2 of MODEL 1.0 embodiment in FIG. 4 on developing alternative scenarios and their impact is now described. FIG. 7 shows the impact of changes in health benefits, and prevention programs for an organization's health care costs. FIG. 7 graphically depicts the impact of investment in programs focused on assisting employees, their family members, and retirees on organization's aggregate health cost liabilities.

In FIG. 7, the top line represents the case of status quo or the case where companies have health benefits with very low co-payments and other incentives, and no investments in prevention programs such as those targeted towards encouraging healthy lifestyles and Best Health Practices. The next line down represents the case where there is no change to health benefits but, there are additional investments made in programs for enhancing healthy lifestyles, and improving Best Health Practices. This causes a reduction in aggregate health liabilities for the organization.

The lowest line represents the case where there are the changes mentioned above are also augmented by changes to health benefits. These lines (trajectories) presented in general form assist in determining ROIs and other project appraisal methodologies in FIG. 4, as each scenario is iterated.

The program evaluation criteria for optimal allocations for health expenditures model for organizations decisions should be based on the same criteria as any other business decision. The optimal investment in health expenditures model for organizations has two main outputs. It provides guidance on the overall allocation for health expenditures in an organization, and it suggests what percentage of that investment should be in prevention programs and related areas that can also assist employees in enhancing the quality of their lives such as information on financial planning, child care resources, etc., which then directly feed into MODEL 2.0 embodiment.

An exemplary MODEL 2.0 embodiment optimizing the quality of life and controlling health care costs is now described. In this embodiment, MODEL 2.0 takes the results of MODEL 1.0 (which determines at the macro level, the extent of investment in enhancing the quality of life including improving healthy lifestyles and Best Health Practices of the employees, their covered dependents, and retirees, as well as other areas), and utilizes some of the resources allocated to provide unique technology tools for individuals associated with these companies.

In other instances, such as for self-employed individuals, individual customers, or people in associations, MODEL 2.0 provides quality of life guidance in financial planning, health planning and management, and information on other vital services such as, child care, etc., through various technology tools described below. Analyzing the underlying theoretical structure for the Quality of Life concept is useful in understanding why people seem to be making decisions that are not in their best interest. Some of this is related to lifestyle choices that are not consistent with the quality of life, while others arise from imperfect market mechanisms that do not sufficiently integrate individual incentives with company benefits plans and the Quality of Life.

The Invisible Hand Principal for Health Expenditures (shown in FIG. 1, Block 235) focuses on a wider set of choices available to the individual not only the financial instruments and associated investment scenarios but also, alternative life choices and their consequences and integration of Best Health Practices, as another set of investment decisions. Thus, individuals simultaneously pick their financial choices, life-style choices, and Best Health Practices for the quality of life, wherein the allocations are different from the pure financial case of portfolio theory. The increased efficiencies from these decisions in turn benefit organizations with which the individuals are affiliated in two areas identified in blocks 113, 113A and 119 of FIG. 4.

It is worthwhile for companies to invest in this approach, because it results in a long run reduction in health care costs in the aggregate. As is well known in economics, consumers save and companies invest. In portfolio theory, it is common practice to consider an individuals allocation of savings to different financial instruments as “investments”. The word investment for the individual is utilized within this context. In one embodiment, the computer software of the present invention focuses on integrating both wealth and health into one mathematical model embedded into the software. The resulting analysis from the software is different and distinct from analysis in the conventional financial models cited above, or of conventional health planning models currently available. For example, U.S. Patent Application No. 2002/0029157 A1, filed on Mar. 7, 2002 discloses a system and process for providing a computerized medical and biographical records database and diagnostic information; and U.S. Patent Application No. 2002/0045154 A1, filed on Apr. 18, 2002, describes a method and system for determining personal characteristics of an individual or group to provide personalized advice or services; the entire contents of which are hereby expressly incorporated by reference. However, the above patent applications do not integrate health of the individuals and do not simulate lost effectiveness of health care and retirement allowance of individuals and organizations.

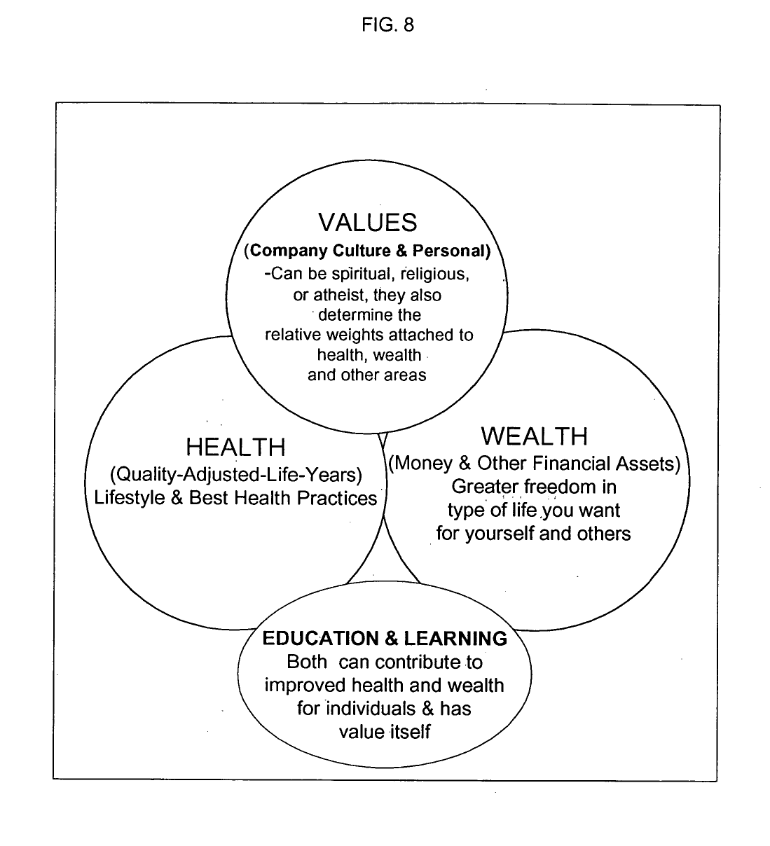

FIG. 8 shows examples of key components of quality of life for people. FIG. 8 depicts how for most people their personal quality of life issues are categorized as those over which they have control, as opposed to those that they do not. Areas where they do have control include their value system, which interacts with their health and wealth choices. Other areas are only controlled through collective action like air pollution, issues with the legal system, etc. A set of tradeoff questions are developed to determine individual preferences for level of health, willingness to change lifestyles (diet, physical activity, etc.), following Best Health Practices, savings rates, and the like, for retirement and other objectives. These questions are related to individual values. Education and learning are also integrated in this model.

Thus, in this embodiment, the present invention develops trade-off preferences for different levels of consumption, wealth, and health, and also integrates details about financial, health, and education information in one database that is maintained in a personal computer (PC) or in a personal storage device. The health profile of the present invention is also capable of tracking genetic impacts of various family members (e.g., mother/daughter inherited conditions, or any other relevant combination).

The software of the present invention focuses on a new class of models that integrate health as an objective as well as education, consumption and savings. While there are many different measures of health for an individual, the invention focuses on Quality-Adjusted-Life-Years and refers to them as QALY. For exposition, someone with a QALY of 70 has had 70 years of life without any major ill-health.

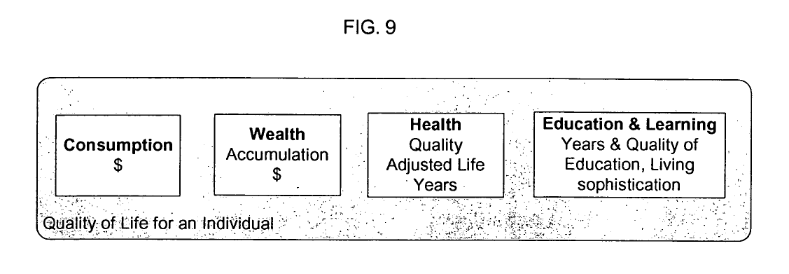

An exemplary objective function of an embodiment of MODEL 2.0 is illustrated in FIG. 9. The software of the present invention departs from MPT model at this juncture, by adding health, education and learning to the model. Also, in the model of the present invention there are different units, monetary units such as dollar and QALY, rather than dollars alone. Education is measured in terms of the normal measures such as years of schooling, and its quality. Thus, instead of maximizing some combination of consumption and wealth under different conditions, the focus of the invention is on maximizing the quality of life under different conditions. In its general form, one embodiment of Quality of Life can be defined as:
QOL=F(C,W,H,EL) (8)

Although, individuals may choose to integrate other variables derived from their personal choices. For instance, some people enjoy altruistic behavior, while others like to spend time in collective actions such as those required by politics, or movements geared to social change. With the usual conditions associated with utility functions and indifference curves and the budget schedules for relevant prices and quantities, new sets of appropriate models are utilized. As an exemplary embodiment, a linear combination for purposes of exposition is presented below:
QOLⁱ=w₀ⁱ(C)+w₁ⁱWEALTH+w₃ⁱQALY+w₄ⁱEL (9)

$${\sum }_{j = 0 , 4}^{i} {W}_{j}^{i} = 1$$

Where, for the ith individual, the weights associated with consumption, wealth, and health are determined by the individual as a reflection of his personal preferences and are restricted in this instance to unity. Quality Adjusted Life Years or QALY are utilized as a measure of well being as defined above. For simplicity, assume that education and learning is measured by years of schooling, and the time spent on acquiring knowledge of savings strategies and general knowledge of the human body. Traditionally, wealth and education are not independent and in fact, education are regarded by many as investment in human capital. However, the focus here is on wealth created by savings in this context, while education and learning have both a wealth contribution and contribution to social standing, and better ability to manage one's life. Thus, both saving strategies lead to wealth creation. Also, education and learning within this context lead to enhanced quality of life for individuals.

In other words, the individual by answering some questions allocates points among consumption, wealth, health, and interest in education and learning that add up to one (1). Examples of such questions include: Now that you are more aware of your wealth and health, how would you prioritize your resources among consumption, wealth and health by allocating 100 points among all three. Then by dividing by 100, the cumulative weights add up to one (1).

QALY for an individual is a function of family predispositions (if the father has heart disease there is a greater probability that the son or daughter will, or if the e.g., mother has breast cancer then it is more likely that the daughter will), their lifestyles (cigarettes, diet and nutrition, exercise levels, etc.), and Best Health Practices (cost effective medical screenings, etc.) for early detection of disease and determine symptoms that need to be treated (e.g. high blood pressure, or high cholesterol levels). This can be represented by the following equation:
QALYⁱ=f(QALY₀ⁱ, LSⁱ, W(h)ⁱ) (10)
Where, QALY₀ is the impact of family predispositions and prior lifestyles, LSⁱ is the Lifestyles Index for individual i, and W (h)ⁱ represents the Best Health Practices index for individual i.

This leads to the updated quality of life objective function of equations (8) to (10), as follows:
QOLⁱ=w₀ⁱ(C)+w₁ⁱΣₛⁱπₛU(Qₛ)+w₂ⁱf(QALY₀ⁱ,LSⁱ,W(h)ⁱ)+w₃ⁱELⁱ (11)

For an individual i with a Quality of Life function (QOL) defined for their individual weights distributed between, consumption, wealth accumulation, Quality-Adjusted Life Year and, education and learning. Where π is the probability of state s, Q is the number of pure securities that are valued for state s, and U is the utility which integrates both the time value of money and the profile for risk. The maximization problem for different levels of risk can be defined as follows:

Maximize the objective function (11) subject to the wealth constraint now spread over additional instruments, as shown below:

$${W}_{0}^{i} = {C}_{gs}^{i} + {\sum }_{s} {p}_{s} {Q}_{s} + {p}_{ls}^{i} {LS}^{ i} + {p}_{Wh}^{i} {W}^{i} ( h ) + {p}_{hc}^{ i} y \qquad ( 12 )$$

In other words, the model of the present invention decomposes what is normally regarded as consumption into four components:
1. A component to increase the Lifestyle Index that requires some allocation of pecuniary assets for instance, purchasing better quality foods, or gym membership. For convenience, a standard pricing unit is utilized for increasing the Lifestyle Index by 1 unit, where LS represents the quantity of Lifestyle Units, increased or decreased.
2. Some of consumption is also allocated to Best Health Practices such as, cost effective physicals, age, sex, family predisposition, specific health screenings, etc.
3. Also, some of consumption is allocated to human capital enhancement whether it is executive education, or an employee taking classes during non-working hours, etc.
4. The residual remaining of consumption is then lumped into C_{gs} or consumption on residual goods and services.

The items in the summation represent the simplified portfolio choices where Pₛ is the price of the pure security for state s and Qₛ is the quantity of pure securities over the state s. All other variables have been defined above.

Thus, just as the individuals “invest” in securities, they also invest in QALY through lifestyle changes, in more effective health screenings, and in human capital. While the marginality conditions are derived utilizing constrained maximization on the Quality of Life Index, the boundary conditions are known. Each dollar invested among the four components, Consumption, Wealth, QALY, and EL should yield the same utility or benefit to the individual. In the absence of any health benefits or incentives to savings and retirements, certain features of this model include:
1. If the individual does not adequately invest in lifestyle and Best Health Practices, the full burden of the reduced QALY is borne by the individual. This includes for example, lost days from work, higher morbidity, higher medical costs, and in the absence of funds a shorter life span.
2. Similarly, if the individual does not save for retirement, or for unforeseen contingencies, the entire burden of retirement falls on him.

With the explicit addition of variables that need to be considered in the quality of life decisions, resources will be reallocated to reflect the decisions particularly for those individuals that were making decisions that were not consistent with their own choices.

In the absence of the integration of QALY into the wealth aspect of Quality of Life, there would be an under-investment in the types of consumption that should be viewed as investment in QALY. There would be an over-investment in goods and services that provide hedonistic and recreational benefits. The individual utilities are not evaluated. Rather, the focus is on people's internal choices, for if they were asked the question, “how important is it for you to remain healthy during your old age?” they would probably show great interest. The organizations would however focus on the costs associated with health care and subsidies by the government.

Referring back to equation (11), W₀ⁱ is the weight associated with C_{gs}ⁱ which is current consumption for the ith individual, and includes both costs associated with health expenditures determined by circumstances, e.g., accidents, unexpected illness, etc. However, W₀ⁱ does not include investment in enhancing the quality-adjusted-life-year such as health best practices, because these investments are regarded as investment in health of the individual in a manner similar to the investments in a retirement portfolio. Thus, the tens of billions of dollars that consumers spend in say weight loss programs are not regarded as current consumption but rather, investments (the scientific merits of the choices made relate to problems of efficiency) in QALY. The case of weight loss is meant to be illustrative and obviously not complete. W₀ⁱ transforms consumption into QOL units.

Wₗⁱ is the weight associated with the growth of wealth in future time periods by the ith individual typically included in part of the objective function of what is called the standard portfolio model. This includes the typical probabilities associated with different states of the world, security prices, and their volatilities (risk and reward, commonly expressed as the mean and variance of so-called investment instruments). Thus, Wₗⁱ transforms each WEALTH unit into QOL units.

W₂ⁱ is the weight associated with Quality-Adjusted-Life-Year in terms of level of absence of morbidity and life span sought. Extrapolations can be drawn from fractional times in bed and other issues such as suffering, etc., and can be subjective. Someone with a higher pain threshold might put a lower weight on QALY, than someone with a lower pain threshold. Similarly, some people may be far more interested in a QALY of 1 for the following year (within the usual mean variance parameters, given their current health status and family predispositions), and some may even over-invest in it. This is not dissimilar to someone putting his or her retirement portfolio in low risk low return savings instead. Therefore, W₂¹ transforms each QALY into QOL units. W₃ⁱ is the weight associated with education and learning EL or human capital.

In equation (12) each of the variables identified in equation (11) are treated as quantities that are multiplied by their relevant prices, that have to be bounded by the individual's wealth constraint. For instance, p_{gs}ⁱ represents the generalized price for one unit of consumption for C_{gs}ⁱ units, just as pₛ represents the generalized price for Qₛ units. pₗₛⁱ is the generalized price for enhancing LSⁱ or lifestyle index units. p_{Wh}ⁱ is the price of enhancing Wⁱ(h) best health practices index units. P_{hc}ⁱ is the price of enhancing y as some composite of years of schooling and quality units as part of education and learning or human capital.

While the variables and the objective function are present in generalized form, the underlying assumptions of the standard model in terms of the use of mean, variance return on investments and the probabilities associated with the different states of the world are maintained. Thus, the focus has been in additively including the Quality-Adjusted-Life-Year and other returns such as those from human capital, political and social causes, which enhance the sense of individual Quality of Life and have economic and non-economic components to them. The Quality-Adjusted-Life-Year (QALY) is important because the standard portfolio model is deficient in not recognizing that if someone plans on retirement at say the age of sixty and amasses a large portfolio, but neglects appropriate lifestyle, and health best practices choices, he may either die prematurely, have greater morbidity, or have much higher medical costs that are borne by a combination of the individual, the company or the state. It impacts the objective function of the standard portfolio model. Similarly, individuals can spend large sums on health expenses that may not be proven, while neglecting their retirement portfolio. So, the conventional MPT model is now a special case of MODEL 2.0 embodiments which focus on the quality of life rather than wealth alone.

By the same token, the QALY also requires different resource allocations for its maintenance, wherein some economic and non-economic costs are associated with it. Economic costs include some Best Health Practices such as, cost effective health screenings, better quality food (not from a gastronomic perspective but from a nutritional and aesthetic perspective).

Also, lifestyle choices (nutrition, exercise, etc.) are also important. However, these choices having a large impact on the objective function of the standard model of portfolio theory are not integrated into it. The effects of the enhancement to the standard portfolio model flow through to the constraints, state variables, and the control variables that go by different names in the standard portfolio model.

For example, the individual's optimal portfolio decision now becomes to maximize QOLⁱ subject to:
Level of Risk Aversion and Constraints, such as:
   Current period Wealth Constraint expressed in the usual Standard Portfolio Model,
   Current Health Situation (Accumulation of past lifestyle, heredity, etc.), and
State Variables, such as:
   Market Risk/Return on different financial assets as in the Standard Portfolio Model,
   Health Benefits Plan Options,
   Relationships between Lifestyle (diet, exercise, etc.) Best Health Practices, family predispositions and the QALY, and
Control Variables, such as:
   Lifestyle (Nutrition, exercise),
   Health Best Practices (Cost Effective Screenings, etc.),
   HSA (Health Savings Account),
   IRA,
   401K,
   Savings Rate, and the like.

Note, when companies pay for health insurance with no co-payments, the risk of not investing in Quality-Adjusted-Life-Year is a greater burden on the company and results in an allocation that is not optimal. In other words, if financial and retirement planning is done without the QALY as an integral element, there is under-investment in it in terms of lifestyle and Best Health Practices by the individual and a greater burden is passed on to the company.

Some of the integrated extensions such as, Lifestyle are harder to quantify and optimize. However, physicians with a specialization in the field can categorize the key medical studies that have demonstrated clear correlations between Lifestyle, Best Health Practices, and the QALY. These quantifications may also integrate hereditary predispositions.

While the present invention allows the individual to develop his individual Quality of Life Index, there is also considerable value in understanding the conceptual relationships established with the Quality of Life Model, in the same way that most uses of supply, demand and implications do not require the calculation of the demand or supply schedule.

Once individuals develop their Quality of Life Index, they can run simulations on the impact of different saving rates, changes in some element of their lifestyle, and health practices, in terms of the different components of the QALY. In the area of health planning, people often do not have sufficient information about their body and the information they receive is often fragmentary. Furthermore, a physician visit that averages about eight minutes is not sufficient to take a look at the whole mind body perspective. This, like the case of financial portfolio management, feeds off incomplete information and experience, resulting in misallocation of resources (e.g., lifestyle choices, and health best practices).

Lifestyle choices often integrate individual risk choices that reflect individual values, as perhaps the excitement associated with risk is built into the human condition. As a result of the integration of QALY into the standard portfolio model, the allocation of assets becomes quite different. Also, the standard portfolio model (although logically consistent within itself) is incomplete, This “hidden” dimension in portfolio theory can overwhelm the visible part.

The overall optimal condition for the portfolio model of this individual according to the present invention is readily discernable, that is, every dollar allocated between the different components of the objective function (consumption, wealth, health, human capital) should on the margin yield the same benefits to the Quality of Life Index for the individual.

In one embodiment, the present invention provides mechanisms for enhancing efficiencies within each of the three categories Consumption, Wealth, and Health.

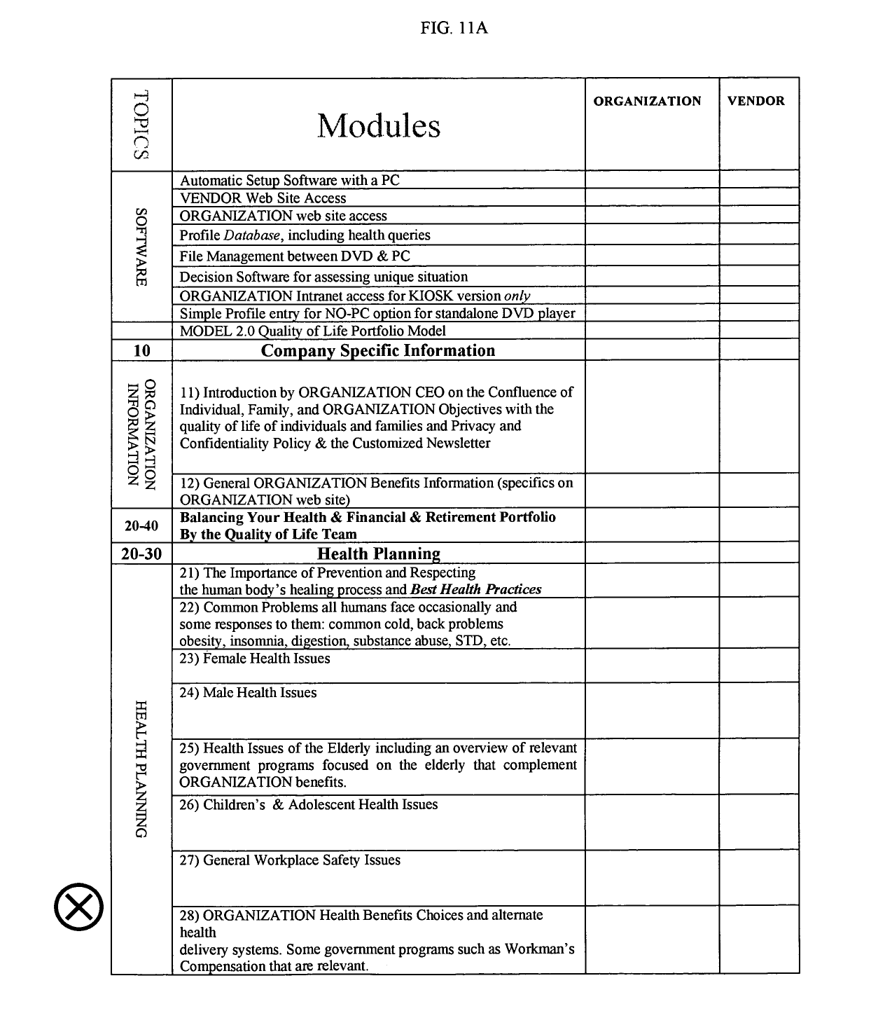

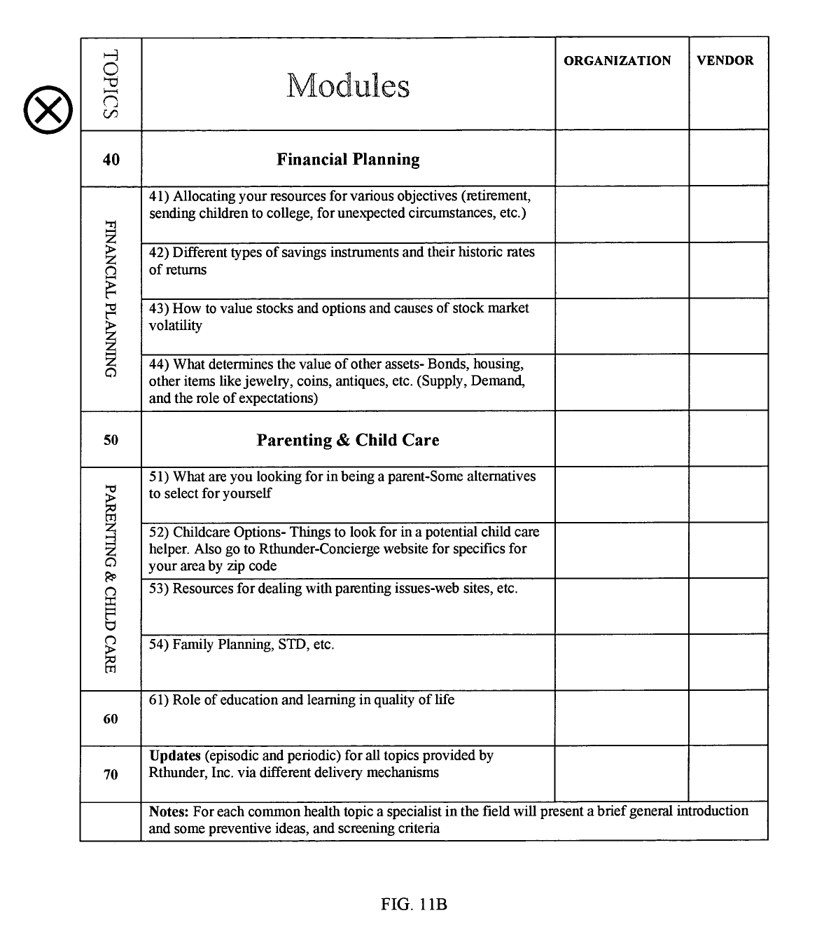

FIG. 11 illustrates exemplary information that can among other media, be contained in a DVD, utilized by one embodiment of Model 2.0. The DVD provides extensive information on the fundamentals of financial portfolio planning including the key factors behind the valuation of financial assets. These guidelines are not meant to beat the market averages but to ensure that people are better informed of the consequences of their actions in a market economy. By the integration with existing financial packages such as, Quickens or Moneys, and the company administered web sites, they can be more efficient in the WEALTH component of their quality of life.

In one embodiment, the information contained in the DVD includes the following categories:
1. Focused and relevant health and finance information to assist people in bettering their lifestyles and Best Health Practices on a completely private and confidential basis.
2. Information on additional services such as childcare, parenting suggestions, toolkits for weight loss programs, related group activities and other areas.
3. General focused health related information for individuals to more efficiently utilize their financial and health related benefits.
4. General information on prevention. For instance, how to avoid back pain, healthy teeth, and healthy diets and substitutions.
5. The role of education and learning.

This information forms the bases for the critical decisions that are made by the employee, family member, and retiree.

More detailed description of one embodiment of MODEL 2.0 is now provided. Wealth accumulation and QALY have some things in common. Both can be treated as assets, one pecuniary and the other human. Thus, just as human capital has been accepted as an asset, so is QALY. Wealth accumulation can be utilized in a number of different ways, for personal consumption later, for dealing with unforeseen needs (a car accident, for instance), and other personal purposes. Similarly, QALY as an asset can be utilized for enhanced productivity on the job, being better prepared for an unforeseen medical emergency (a car accident for instance), and for its own consumption.

This embodiment of MODEL 2.0 treats cost efficient health examinations and screening as part of investment in Quality-Adjusted-Life-Years (QALY).

In the objective function of equation (11), W₀ represents the weight allocated to consumption excluding health best practices (defined below). Where, W₁ is the person's personal preference devoted to the acquisition of wealth, and W₂ is the person's personal preference to attaining large Quality-Adjusted-Life-Years. The sum of these weights is one to signify that there are choices that have to be made.

The changes to lifestyle can have a pecuniary component to them. Best Health Practices have a larger pecuniary component because they include cost effective screenings (e.g., age, gender, and family predisposition physicals and screening tests)

The QALY can also be improved by non-pecuniary allocations, which are related to lifestyle changes (diet, exercise, etc.).

For any given age, gender, family predisposition, there are optimal lifestyles, which encompass diet, physical fitness, social interaction, etc., and a scale of 1-100 is designated to them. Thus, a lifestyle of 100 for a middle-aged male of a particular height and build with no apparent health problems (weight, disease, etc.) may for example, include:
1. 1 hour of moderate exercise everyday,
2. 5 servings of fruits and vegetables everyday including vegetables that are high in fiber and are calciferous (prevent cancer to some extent),
3. No more than 1 alcoholic drink per day (some debate-Mormons vs. the rest of the U.S. population),
4. Certain maximum calorie and carbohydrate count,
5. Some mineral supplements, and
6. A balanced diet.

Similarly, one could define the health screenings for the individual as:
1. A physical checkup every year, and
2. Regular dental checkups.

In the extreme, a lifestyle of 0 would be merited if someone did not have enough food, much less a balanced diet, while a poor diet, no exercise, inadequate fruits and vegetables would merit say, a 60, and so on. For ease of exposition, statistical variables are not utilized here.

Accordingly, the optimization conditions for QALY become:

$$\frac{\partial {QALY}^{ i}}{\partial {LS}^{ i}} > 0 \qquad ( 13 )$$

$$And \frac{\partial {QALY}^{ i}}{\partial W {( h )}^{i}} > 0 \qquad ( 14 )$$

The second order derivatives are:

$$\begin{matrix}\frac{{\partial }^{2} {QALY}^{i}}{\partial {LS}^{2}} < 0 \\ and & ( 15 ) \\ \frac{{\partial }^{2} QALY}{\partial W {( h )}^{2}} < 0 & ( 16 )\end{matrix}$$

In other words, a positive lifestyle enhances QALY but with diminishing returns, otherwise we would be immortal, as is the case with cost effective screenings. It is assumed that LS and W(h) are defined on the real closed line interval [0,100].

Typically, Lifestyle and Best Health Practices are not linearly or stochastically independent, and in fact interact. Similarly, health screenings can also be optimized (economically cost effective) for any given age, gender, family predisposition, etc. The lowest level is designated as zero.

There are two health constraints in the above example. The first one represents the maximal lifestyle that is possible for QALY. For instance, above one hour of exercise per day or more than five servings of fruits and vegetables do not yield any additional benefits to QALY. The second constraint is the maximal Best Health Practices constraint. At some point, over-active screenings can have a more negative impact on QALY than a positive one. When this constraint interacts with the wealth constraint, they result in cost effective Best Health Practices. Since lifestyle and Best Health Practices costs are subtracted from current consumption, the residual consumption is now C′.

Therefore, for the objective function, the wealth constraint is now spread over additional instruments:

$${W}_{0}^{i} = {\sum }_{s} {p}_{s} {Q}_{s} + {C}_{gs}^{ i} + {p}_{ls}^{i} {LS}^{ i} + {p}_{Wh}^{i} {W}^{i} ( h ) \qquad ( 17 )$$

With all variables defined earlier, just as the individuals invest in securities, they also invest in QALY through lifestyle changes, and more effective health screenings. While the marginality conditions are derived by utilizing constrained maximization on the Quality of Life Index, the boundary conditions are known. As stated earlier, each dollar invested among the four components, Consumption, Wealth, and QALY or any other variable should yield the same utility or benefit to the individuals Quality of Life. In the absence of any health benefits or incentives to savings and retirements, certain features of this model should be noted:
1. If the individual does not adequately invest in lifestyle and Best Health Practices, the full burden of the reduced QALY is borne by the individual. This includes lost days from work, higher morbidity, higher medical costs, and in the absence of funds, a shorter life span.
2. Similarly, if the individual does not save for retirement or for unforeseen contingencies, the entire burden of retirement falls on her.
3. The largest returns to the model comes from changes in behavior without any costs.
4. By integrating the Health Savings Account with tax-deferred savings, individuals experience incremental gains in terms of wealth.

Thus, the issue becomes, how the individual's decisions change as a consequence of integrating the MODEL 2.0 embodiment. Just as in the case for the efficient market hypothesis for securities, perfect information among buyers and sellers lead to economic efficiencies for consumers and companies, similarly the integration of QALY into the equations along with appropriate modifications to existing benefits programs in organizations will lead to a more efficient allocation of individual and organizational resources. Just as information flows and price signal are the key to efficient markets, so too, the availability of health planning information, financial information, and other areas are key to efficiencies for enhancing the quality of life and controlling health care costs.

In the absence of the integration of QALY into the Wealth aspect of Quality of Life, there will be an under-investment in the types of consumption that should be viewed as investment in QALY, and an over-investment in goods and services that provide hedonistic and recreational benefits. This embodiment of MODEL 2.0 does not evaluate individual utilities, but rather focuses on people's internal choices, for if they were asked the question, “how important is it for you to remain healthy during your old age”, they would probably show great interest. The organizations would typically focus on the costs associated with health care and subsidies by the government.

In the absence of any government or business subsidy, an efficient MODEL 2.0 embodiment has similar requirements to perfect capital markets, such as:
1. Markets are frictionless, i.e., there are no transaction costs or taxes, all assets are perfectly divisible and marketable, and there are no constraining regulations.
2. There is perfect competition in product and securities markets. In product markets this means that all producers supply goods and services at minimum average cost, and in securities markets it means that all participants are price takers.
3. Markets are efficient, i.e., information is costless and is received simultaneously by all individuals.
4. All individuals are rational expected utility maximizers.

Once individuals are aware of aspects of their consumption that can be utilized to enhance their QALY and therefore their QOL, they will be less likely to accept the imbalance of a large wealth or retirement portfolio and low QALY from a low quality lifestyle and poor Best Health Practices.

The above objective function may be integrated with employee benefits. These benefits are integrated in a most general form and implications derived in terms of employee responses to them from the base case above. These benefits for Wealth and QALY can be also optimized in a manner similar to the efficient market hypothesis. Financial benefits (e.g., 401K and IRA) can also be integrated with the objective function. Also, different types of health benefits are modeled into the objective function. The 401K has two components: one the percentage that is contributed by the employer and the employee contribution. This can be modeled as the tax differential arising from the standard portfolio and the employer contribution as a subsidy.

For the moment we ignore the loss of liquidity and tax penalty for early withdrawals. The IRA also has the tax benefit contribution, but there is usually no employer contribution. So now, the Wealth component of the objective function can be modified as the Employer and Tax Benefit Modified Wealth function, or ETWEALTH for short:
ETWEALTH=ΣₛⁱπₛU(Qₛ)+(TXDEF) (18)

In other words, the standard portfolio model has an additional component that integrates the incremental benefit of tax-deferred income and the company match to the 401k. In this case, the impact of human capital is omitted.
QOLⁱ=w₀ⁱ(C′)+^{w}₁ⁱETWEALTH+w₂ⁱf(QALY₀ⁱ, LSⁱ,W(h)ⁱ) (19)

Where the Quality of Life Objective function has been modified to include the tax implications and the employee's contribution to the 401K. Additional organizational compensation such as stock options, etc., are not integrated in the above equation, as they have different valuation mechanisms associated with them.

With the tax deferment, the 401Ks and IRAs have a higher real rate of return associated with them. Also, in the case of the 401K, often diversified bundles of choices are presented which are more likely to mimic market behavior than individual choices in most instances. So, rationality would dictate that other than for liquidity issues, non-health savings should flow into a 401K and IRA first where the real returns are higher compared to the case of non-tax deferred and non-matched contributions. The integration of the tax deferred 401K and IRA with company match does not change the wealth constraint. However, it increases the total return on the portfolio's wealth as part of the quality of life objectives.

The Health Savings Account (HSA) can also be integrated as follows:
HSAⁱ=aCₕⁱ+(1−a)f(QALY₀ⁱ, LSⁱ,W(h)ⁱ) (20)

In other words, the HSA is either spent on the health component of current consumption (e.g., in case of illness), invested in QALY, or if withdrawn after 65, can contribute to ETWEALTH without penalty, where “a” represents the percentage of HSA allocated to current health consumption, and (1-a) represents the percentage allocation to QALY. In other words, the employee has the option of utilizing HSA to pay for some current health problem, enhance QALY within the objective function as part of the quality of life by appropriate investment or by picking a higher percentage of non-pecuniary changes to lifestyle, and thus allocating it to ETWEALTH after 65. It should be noted that health costs due to illness are covered by the HSA, as consumption. An alternative formulation would be to simply add the HSA to the wealth constraint. While for government regulation and taxation purposes, the HSA is kept separate for the above purposes, and for resource allocation purposes its tax deferred income potential becomes important.

Since the HSA is a contribution by the employer, the wealth constraint is enhanced. The standard health insurance benefits provided by employers, where either part or all of health care is subsidized by the employer, has different implications.

At its simplest, the HSA subsidizes improved QALY, however, if the employee chooses not to focus on QALY and acquires some disease that could have been avoided, it also subsidizes morbidity either wholly or in part. Exemplary cases of this are cigarette smoking and being obese, which is in turn subsidized by the HSA. In other instances, there are Best Health Practices that are not followed with the same consequences.

The model then enhances the efficiency of the market in terms of clarifying the responsibilities of the employee, and also in providing key information on health, wealth and other areas that results in more efficient allocation of resources consistent with the interest of the employee.

The new wealth constraint can now be modified as the original wealth constraint without the HSA, that is, equation (17) is now augmented with the wealth constraint.

This can be done with allowing full flexibility for the HSA in that it is primarily focused on health care expenses, but the residual is allowed to be rolled over into future years and can be withdrawn without penalty after 65. The health allocation as before is focused on illness related expenses as consumption, on investment in QALY, and the residual in effect becomes an addition to ETWEALTH. Since ETWEALTH does not show up in the wealth constraint, the residual from HSA augments the returns in the objective function by enhancing the employer contribution in ETWEALTH above.

Accordingly, HSA can be viewed by healthy individuals who maintain a high lifestyle index, as an augmentation of their wealth portfolio. It should be noted that the more non-pecuniary allocations that a person makes to a healthier lifestyle, the greater this benefit accrues to the individual.

If the individual has a low lifestyle index, or is sick from other causes, this ETWEALTH benefit will be smaller. The augmented equation (17) is represented as follows:

$$\begin{matrix}{W}_{o}^{ig} = {W}_{o}^{i} + {HSA}^{i} \\ = {\sum }_{s} {p}_{s} {Q}_{s} + {C}_{gs}^{ i} + {p}_{ls}^{i} {LS}^{ i} + {p}_{Wh}^{i} {W}^{i} ( h ) + {XLS}^{ i} + {HSA}^{i}\end{matrix} \qquad ( 21 )$$

There is a new larger wealth constraint, W_{0ig} the new wealth constraint now includes HSA, i.e., HSA is seen as an augmentation of the wealth constraint, which is first focused on health care needs of the individual (health consumption and investment in QALY) with the residual to be allocated among the securities. The constraint of equation (20) is preserved.

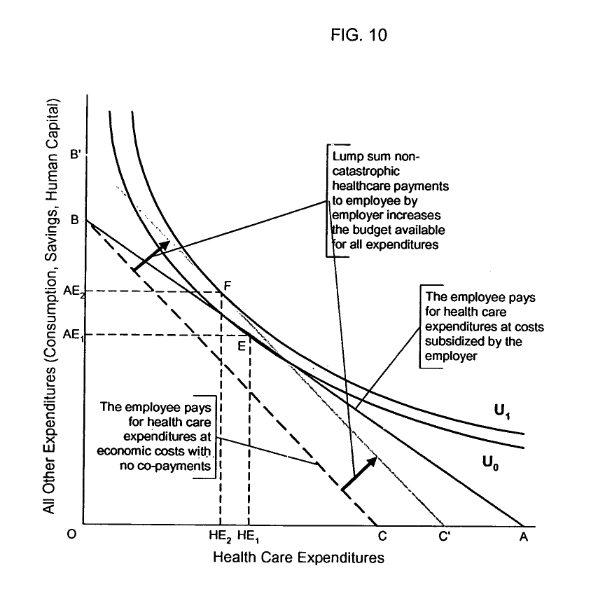

FIG. 10 is a graphic illustration of the Invisible Hand Principle of Health Expenditures. The diagram demonstrates how people's expenditures on health differ when it is their own money, as opposed to having it heavily subsidized by someone else, for example, their employers. It should be noted that these policy implications hinge on designing programs that provide sufficient education to employees, families and retirees both on information that serves as the basis of their individual decisions, and the designing of health programs that are priced as close to economic costs as possible.

In one embodiment, MODEL 2.0 of the present invention (after data input from each employee, family member, and retiree) can develop the optimal choice of investments in QALY (lifestyle, Best Health Practices), and the optimized financial retirement portfolio, based on the benefits programs provided by the employer, the age of the individual, their unique family predispositions, and other family situations. This conjoint health, wealth, and human capital optimization ensures that individual decisions are consistent with the Quality of Life selected by the individual.

With the conditions for an efficient market in the background, the information requirements for such individual optimizations become quite daunting. In addition to the optimization capability, individuals need to be aware of how changes in their behavior will directly impact their quality of life, in terms of QALY and financial implications. Accordingly, a simulation capability is also provided, in an embodiment of the present invention.

In this context, simulation means the ability to determine the impact of, for example, a person reducing his or her cigarette intake from two packs a day to one pack a day, and its implications in terms of QALY and wealth implications. Similar simulations can be carried out for weight loss programs, for example the implications of losing ten pounds on QALY and wealth implications. The invention also integrates changes in behavior say, reducing calorie counts, or increasing intake of fruits and vegetables and the implications for a particular individual, given his unique situation. On their personal computers or in other environments described below, people can see their QALY and their wealth endowment change as they make appropriate lifestyle choices, follow Best Health Practices, or enhance their savings rates, etc.

These simulations, besides the impact on QALY and Wealth also recommend appropriate benefits choices for the employee, family member, or retiree, consistent with the information entered and the choice set of company benefits. As the analysis above would also suggest, the recommended financial savings are first allocated to the 401K and the IRA due to the company matches and tax benefits, and the result shows up in terms of a higher Wealth endowment versus the same amount of savings that are not sheltered, with appropriate liquidity considerations. This enhances the sensitivity to more efficient resource allocation and its implications.

Similarly, for older employees, the recommended choices in lifestyle (diet and exercise) and Best Health Practices are different from younger employees, just as the financial allocations recommended are different (less risky, lower return). Recommendations on leaving a will, etc., to minimize inheritance taxes, etc. are also integrated, in one embodiment of the present invention. After employees, their family members, or retirees have fine-tuned their recommended choices, they will be able to automatically update their choices on the company's web site in terms of their preferred benefits.

The aggregate present value of lifecycle health costs for all employees, their covered family members, and retirees are calculated. This is based on the types of benefits by employee category (occupation, type of benefits, etc.), their age which determines the extent of the liability, and the aggregate number of each type of employee.

Then based on standard actuarial tables, as well as current public health indicators of effectiveness of programs, program valuations that would support an improvement in health indicators up to certain levels up to the optimal Lifestyle and Best Health Practices level are determined. These valuations determine-the efficient level of investment by the company in the MODEL 2.0. Since this efficient level of investment is dependent on company specific information, it will be unique for each company. The conceptual framework can be generalized to integrate some human capital issues as well. Therefore, the more general issue becomes an optimal investment criteria for human capital in a company including health investment.

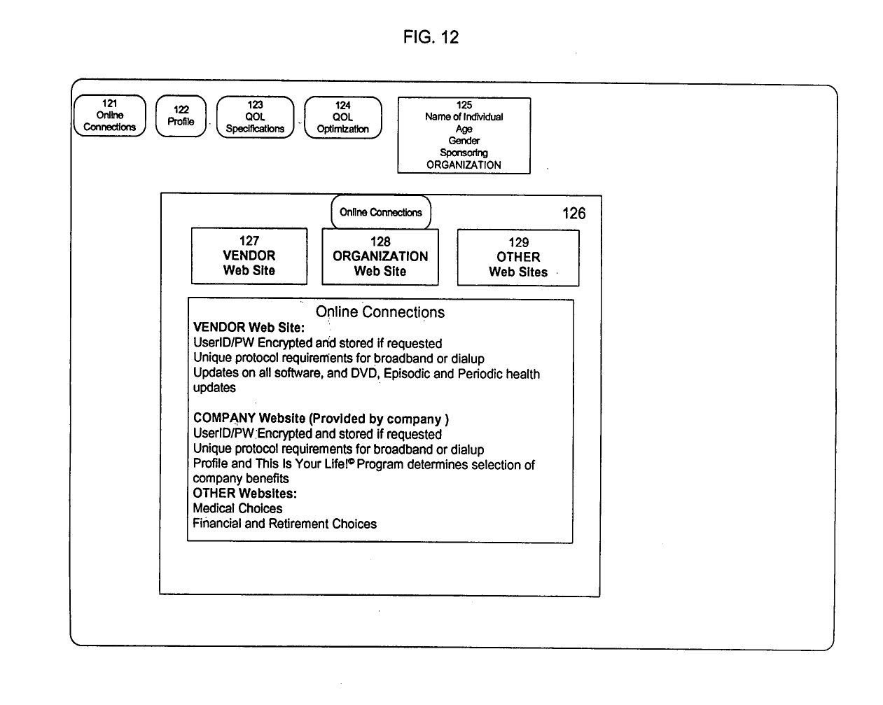

FIG. 12 depicts an exemplary user interface (UI) for online connections for MODEL 2.0. An online connection button 121 establishes communications parameters with organization, vendor and other websites. A profile button 122 is used for data entry of the individual's personal information regarding wealth and health, etc. A Quality of Life (QOL) Specifications button 123 is used for entering the unique characteristics of the individual such as their lifestyle, and Best Health Practices. A Quality of Life (QOL) Optimization button 124 determines optimal health and wealth strategies to be followed by the individual based on the information entered including their own preferences.

In the middle and top of the screen, the name of the individual and a few key demographic items and the name of the sponsoring company are shown in area 125. If MODEL 2.0 is independent of a sponsoring organization, the related information will not appear here. Screen 126 shows that the online selection has been activated and also shows the different information that has to be entered by a user for online connections. Vendor website button 127 presents the dialog menu for entry of relevant information for accessing the vendor's website. Organization website button 128 focuses on the data input requirements for automatic access to the organization's web site such as user id, password, and other information provided by the organization. Other Website button 129 integrates information for other websites provided by the MODEL 2.0 DVD or related media, or entered by the individual.

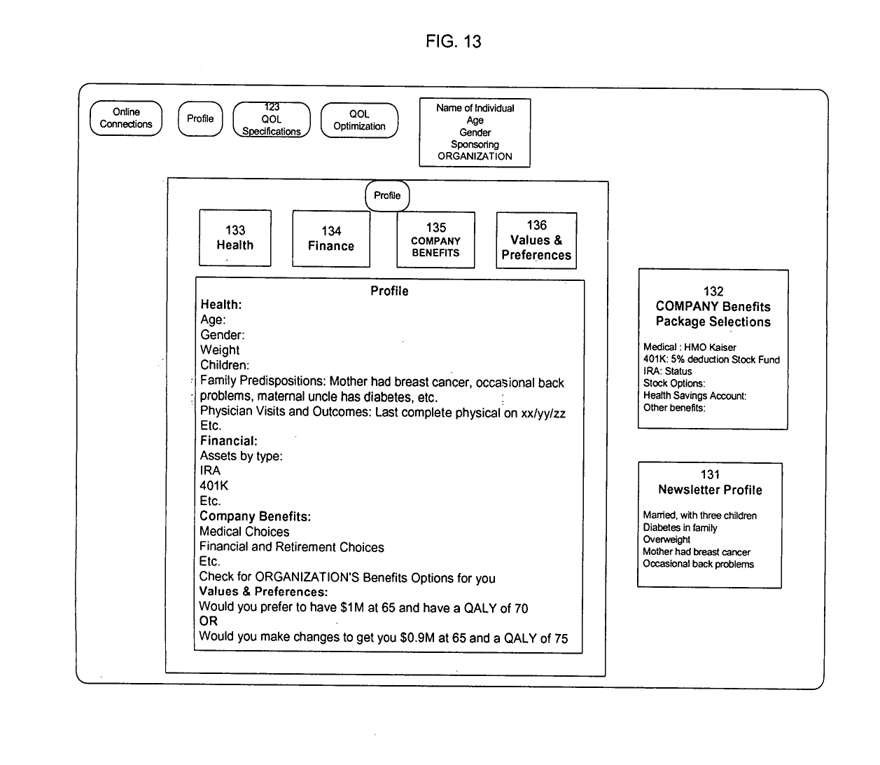

FIG. 13 shows an exemplary profile section and sub-menus for entering information about the individual regarding health, wealth and company benefits information. Based on the profile entered, area 131 automatically develops the specifications for the customized newsletter integrating relevant information requirements for each individual in the household. The information includes relevant health information, financial information, any company specific information, and other information that is unique to the requirements of a particular household. As one example, if the household has children that are of the age to require childcare, information on licensed childcare facilities in the area are provided. For a single senior citizen retiree, such information would not be specified instead, there would be information on say Medicare integration with company health benefits. The customized newsletter and area 132 includes information about organization benefits such as, name of the medical insurance provider and information about 401 K and IRA selected options and status. The organization benefits information is updated by automatic access provided to the relevant website, and can also be entered manually. The buttons 133, 134, 135, 136 provide selective access to sections of the profile for ease of data entry where appropriate.

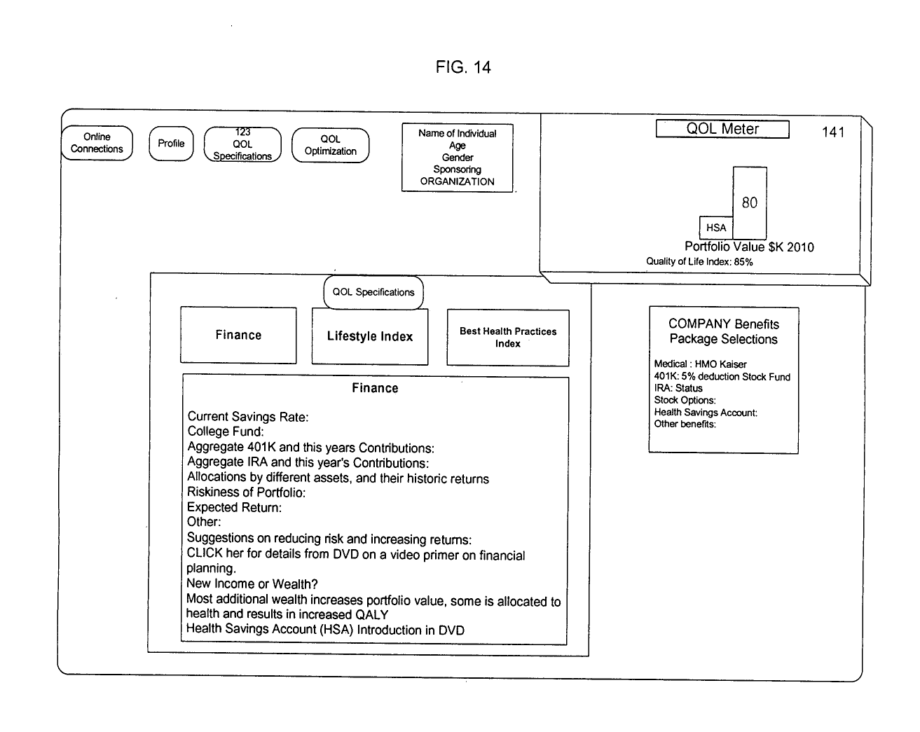

After the profile information has been entered, the end user clicks on the QOL Specifications button 123 to bring up a Finance, Lifestyle Index, and Best Health Practices Index, an example of which is shown in FIG. 14.

In the exemplary screen of FIG. 14, the Finance section of the QOL Specifications menu 123, that is, finance is elaborated. This screen consolidates all information from the individual including the savings rate, retirement information, consolidated financial assets and savings, along with a choice to get more information on reducing risk for the same return or increasing return for the same risk. The Health Savings Account information is also entered here. Then all health-associated expenditures are logged in this screen. A subset of the Portfolio Value (Quality of Life Meter (QOL Meter)) is highlighted in area 141, as being a consequence of the Health Savings Account (HSA). In one embodiment, the QOL Meter has only the portfolio value and the HSA if available to the individual or household. In all instances here and below, the width of the bars represents risk and the height of the mean.

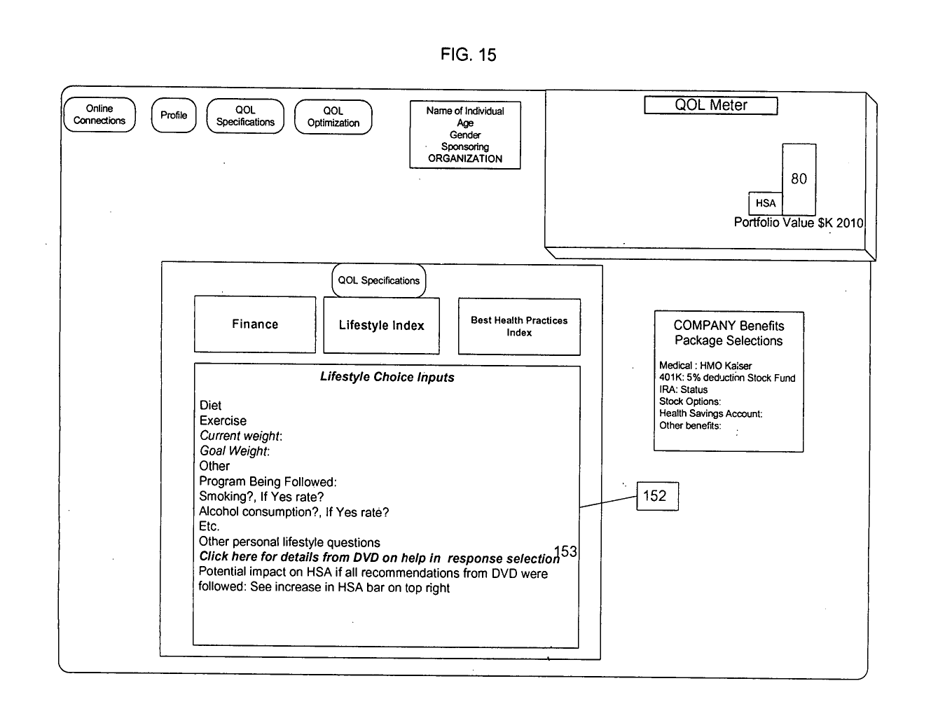

In FIG. 15 illustrates an exemplary specification for the Lifestyle Index including a screen 152 for the lifestyle choice inputs. The response to this information determines the Lifestyle Index for the individual which is one of the determinants of Quality Adjusted Life Years. A set of questions are suggested similar to those often utilized by physicians on the first visit. The questions include for example, if individual is smoking and if yes, the consumption rate. Similar questions are asked regarding alcohol and other drugs. Personal questions about lifestyles can be asked because the information always remains in the possession of the individual, and never needs to be communicated. When the user clicks on say a DVD button 153, appropriate video selections are played providing suggestions on the responses and providing additional helpful information. This information is also picked up for the customized newsletter.

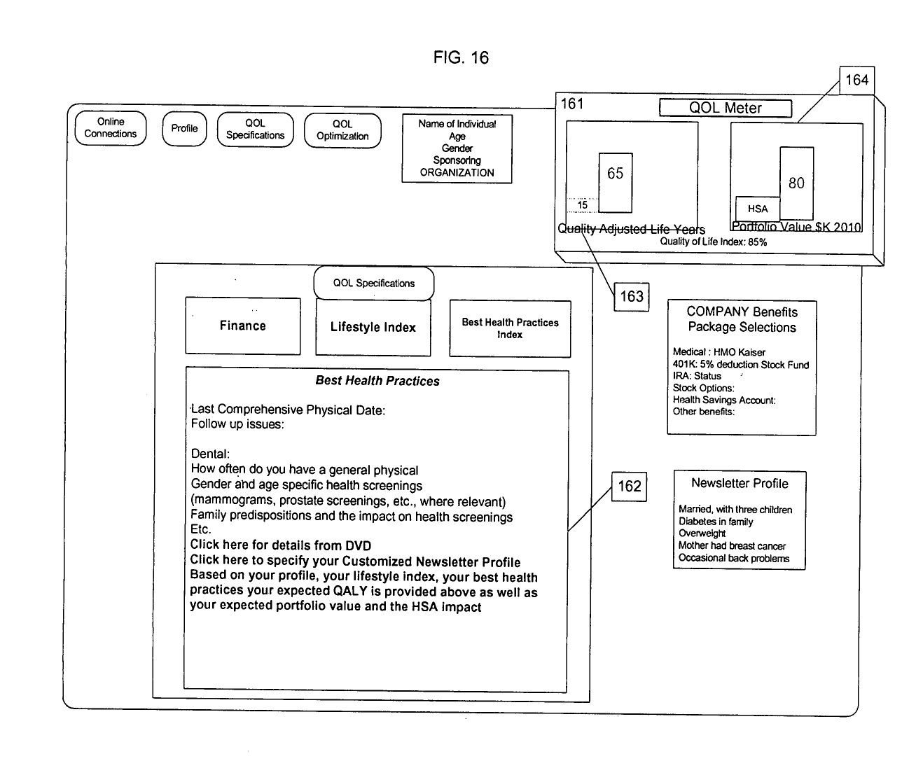

Similarly, in FIG. 16, a Best Health Practices Index 162 is generated from user inputs, and by pressing the DVD button the individual is provided videos consistent with his or her profile that provide recommendations. The types of questions addressed in 162 include gender and age specific health screenings and impact of family predispositions. Now, the individual profile, the lifestyle index and the Best Health Practices determine the expected Quality Adjusted Life Years for the individual. For this individual, the Quality Adjusted Life Years appears as 65 in screen 161. The QOL Meter has two entries now, Quality Adjusted Life Years, and Portfolio Value.

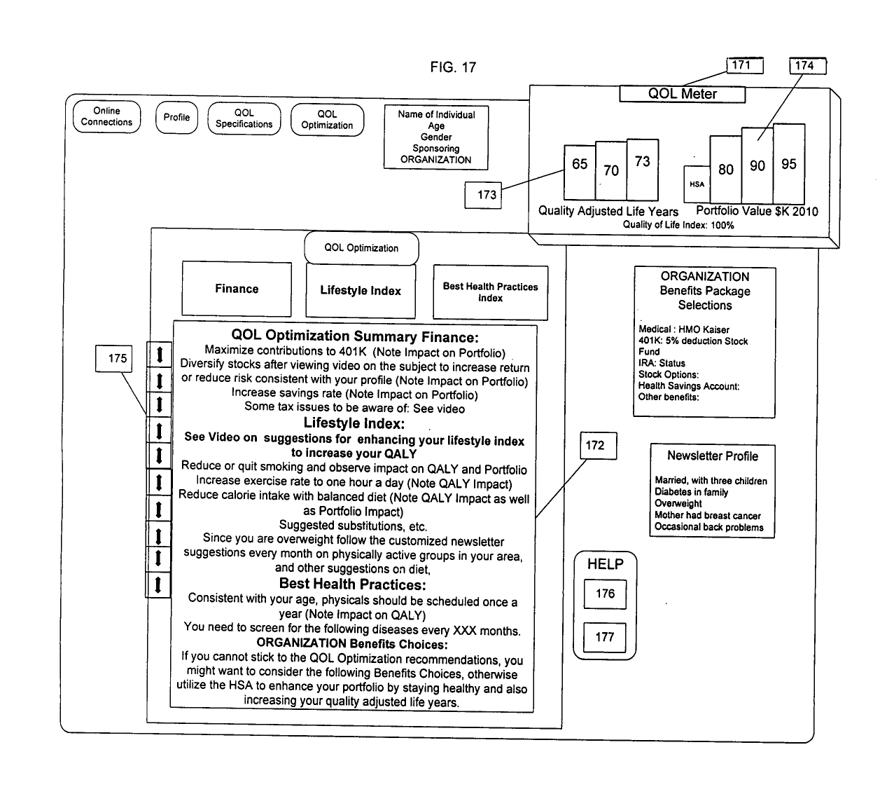

As the information on the Lifestyle Index, Best Health Practices, and finance are shown, the top right of the Quality of Life Index screen shows, the expected Quality Adjusted Life Years for the individual in area 163, and the individual's Portfolio Value in area 164 for 2010, as an example. The user is then in a position to determine Quality of Life Optimization, as shown in FIG. 17.

FIG. 17 provides one set of examples on Quality of Life Optimization recommendations. The dialog boxes 175 on the left allow individuals to change the values associated with say cigarette smoking, balanced diet calorie reduction, changes in exercise, etc., which lead to changes in the lifestyle index, Best Health Practices, or financial indicators. These changes in turn impact the QOL Meter. After optimization the height of the bar is interpreted as the mean value of Quality Adjusted Life Years, and of the portfolio value, and the width of the bar correlated with “risk” as utilized in MPT. Other mean-variance analysis is applied to both Quality Adjusted Life Years as well as the portfolio and the HSA.

As the user changes the lifestyle index for example, by quitting smoking, QALY increases consistent with best health information, and the Portfolio Value also increases assuming that all money saved from buying cigarettes is put into some form of savings accounts. (The preference trade-offs associated with the profile would determine actual behavior and the resulting impact). The same set of arguments apply for any other changes to the lifestyle index or Best Health Practices. For some health practices, such as reducing calorie intake but maintaining a healthy diet, the impact may only be on QALY and thus affecting the Quality of Life Index but not the Portfolio Value.

When in FIG. 17, changes to the savings rate are made, as one example on the dialog buttons on the left with up and down arrows, the portfolio selection is altered in the same manner to make it less risky through diversification, or return is increased with increased risk, the major impact is in Portfolio Value. To the extent that individuals have specified their preferences towards health, they may choose to allocate some of the increased wealth towards Best Health Practices and thus increase QALY.

As people pick healthier lifestyles or better health practices, the HSA highlighted component increases. Similarly, the HSA highlighted component declines with less healthy lifestyles or less Best Health Practices. As people select alternative strategies through optimization to increase return for the same level of risk, the exemplary portfolio value increases. As they select even higher returns by picking higher risk levels the width of the bars on the portfolio values narrows. If some of the increased resulting wealth is allocated to Best Health Practices (better cost effective screenings), it will have an impact on QALY.

After the profile has been entered one of the button on the screen allows individuals to get specialized information from say a DVD. The HELP Menu has two buttons associated with it 176 and 177. Button 176 focuses on providing context sensitive help for any of the commands on the screen. This is accomplished by highlighting the command and clicking on button 176. For help from the DVD or other media, the KIOSK and the Internet, button 177 is pressed and results in the appropriate video being played, for quitting or reducing cigarette smoking. Alternative formulations of context sensitive help menus can also be accommodated.

Since the information is important, it is kept updated by the Internet or some internal organization communications network.

In one embodiment, any enhancement, or updates to the MODEL 2.0 DVD are stored on the hard drive of the PC.

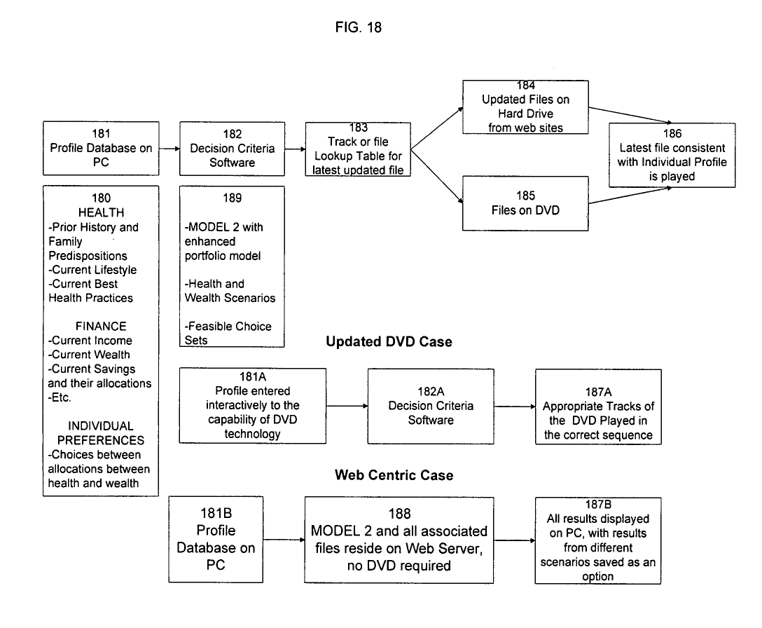

FIG. 18 depicts an exemplary block diagram for MODEL 2.0 interaction with the PC-DVD and with the standalone DVD. As shown, the profile is stored on the PC or on off-line media such as CD-RW, DVD-RW, etc. The software then determines the information that needs to be fetched from the lookup table 183. The lookup table directs the individual to the latest versions of the information, either on the hard drive or on the DVD. This environment is referred to as the PC-DVD-Internet configuration hereinafter. Block 181 represents the profile database generated earlier and Block 180 summarizes the categories of information entered. The Decision Criteria Software in Block 182 includes the enhanced portfolio model software where the quality of life optimizations are carried out. Block 182 also integrates the external information required for the financial portfolio and the wealth and health scenarios optimization. Once a query is initiated from the individual, the decision criteria software passes on the request to Block 183, which determines where the latest version of the data reside. For the DVD, the updates are stored on the hard drive, so the lookup table determines the latest versions of the file and fetches them, either to Block 185, if the DVD data for this query is current, or to the hard drive for the updated version in Block 184. In either case, the latest updated version of the file is fetched in Block 186.

In some instances the individuals will be mailed freshly updated versions of the DVDs with the latest data, where this is referred to as the updated DVD case. In this case, the decision criteria software of Block 182A plays a larger set of videos utilizing a subset of Block 182 as Block 182A and the tracks are played with some of them less relevant than the PC-DVD-Internet combination described above, as shown in Block 181A.

In the web centric embodiment, only the profile database is stored on the PC or on an off-line storage device. Everything else including the decision criteria software Block 188 is stored on the web. All the results are viewed on the PC, as shown in Block 187B.

KIOSK configuration is when such functionality is provided in an organizational environment, with information available that is updated through internal company communications, and the individual profile is stored on off-line storage. KIOSK configuration has the same functionality as the PC-DVD-Internet configuration.

In the updated DVD configuration, a simplified version of the profile is entered in response to answers to the questions, and appropriate tracks are played in response to the answers.

Finally, there is a web-centric embodiment where only the profile is developed and stored locally, all other information resides on the Internet and thus no DVD is required.

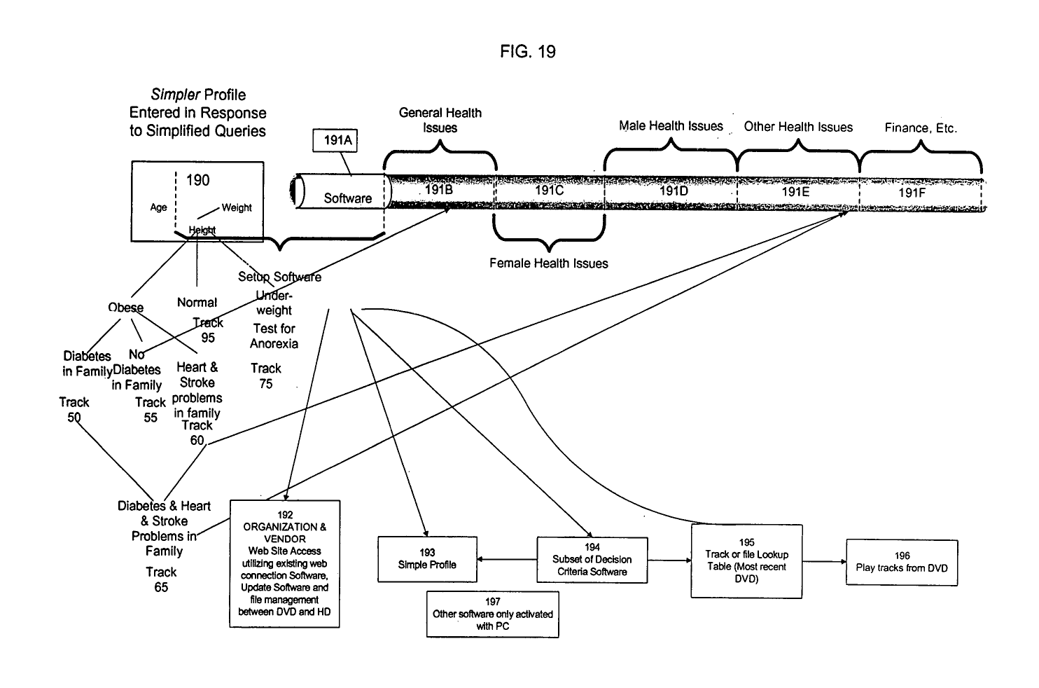

FIG. 19 illustrates an exemplary simple DVD configuration. In one embodiment, the simple profile leads to a superset of the video accessed by the profile developed on the PC. Updates may be received through a newsletter. FIG. 19 provides more details about the mechanisms for the updated DVD configuration. As the profile is entered, decision analysis software determines appropriate tracks of the DVD that should be played. This is referenced as the No-PC option configuration. In this embodiment, all software is resident on the DVD, and when inserted into an appropriate PC configuration, it becomes the PC-DVD-Internet configuration. The information on the DVD is the same as for the PC case, but accessed in a simplified manner.

In Block 190, a simple profile is entered on the DVD, and on the basis of the individual's gender, age, weight, and height and other variables appropriate video tracks are presented for the individual. For instance if someone is overweight, he will be directed to Block 191B. If there is a family predisposition to breast cancer, a female individual will be directed to Block 191C. While not shown, the other topics covered in FIG. 11 are also available here. For instance 191D contains male health issues, 191E could integrate gerontological issues, 191F finance issues, etc. In other instances the profile is more sophisticated, but utilizes aspects of the approach discussed in FIG. 19 with various media.

Therefore, the DVD setup software in the standalone mode includes the setup software discussed earlier, a simpler version of the profile 193, decision criteria software in Block 194, and the look up table 195 focused on the DVD alone in this instance and the videos in Block 196. All other software is activated by the PC 197.

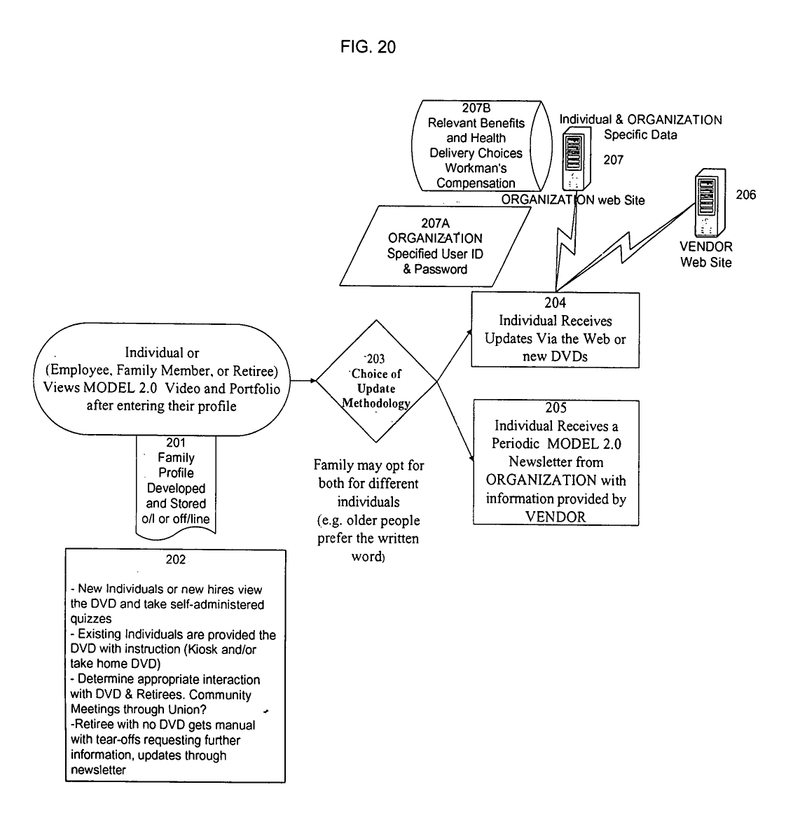

FIG. 20 shows an integration of the different environments to meet the needs of people with different settings and skill sets, according to one embodiment of the present invention. In block 201, the independent individual, the employee, the family member, or retiree, enters the individual profile, as part of a family profile and stores it on a PC or on an off-line storage. As shown in block 202, new individual or new hire views the DVD and takes self-administered quizzes. Existing employees have access through Kiosks or through take home DVDs. Retirees or others with appropriate equipment are provided with DVDs, and dependent on circumstances, web access, books, or Customized Newsletters.

In block 203, the individual or family gets to determine the choice of update methodology such as, update via the Web or new DVDs (block 204), or newsletter (block 205). The user may opt for both options. The employees receive relevant information from the organization's website 207 through an ID/PW combination 207A on relevant benefits, and health delivery choices, etc. 207B. The vendor website 206 provides episodic and periodic updates for health and finance related information, which is stored on the PC. Each individual and family receive a personalized and customized MODEL 2.0 video updates for their relevant health profiles and benefits, as well as other information.

The other choice of update methodology is a customized newsletter. Here as explained earlier, the family and individual profile, and lifestyle issues determine contents. Retirees, for example, would with greater frequency be expected to opt for the customized newsletter.

For the newsletter, the vendor would provide the contents, and the software for its integration with the individual and family profile, and the organizations Central Reprographics Department (CRD), data center, or other appropriate departments or entities, CRD with access to employee and retiree data would compile the customized newsletter for distribution. The newsletter is distributed by mail (paper, or offline storage), fax, and email or other electronic means of distribution. Each individual's MODEL 2.0 newsletter is personalized and customized for his or her relevant health profiles and benefits. The newsletter may also include advertisements and other information for related products.

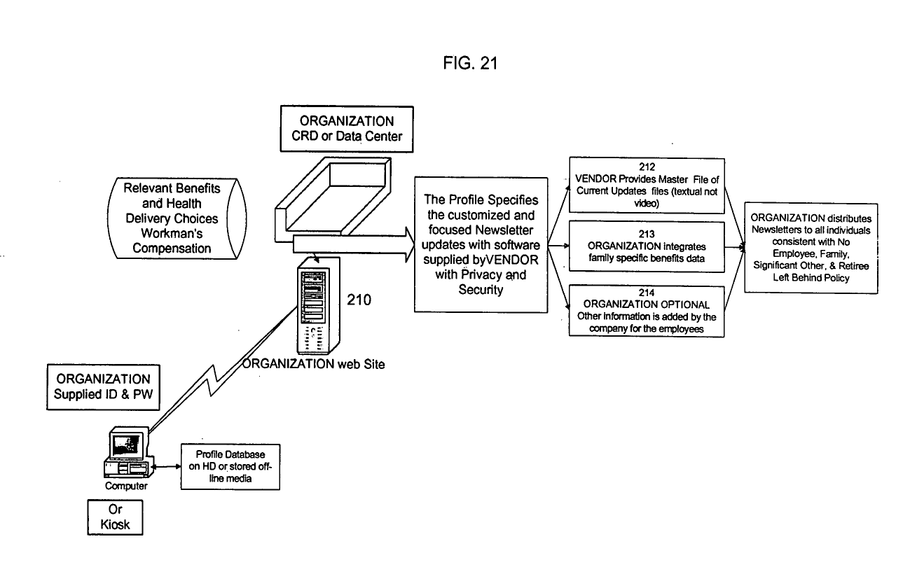

FIG. 21 shows an exemplary mechanism for the specification and distribution of the customized newsletter. After the profile and related information is created on the PC or off-line, it is specified on the Organization's website 210, without any of the profile being communicated. In one embodiment, the newsletter has three broad components. One set of data is provided by the vendor 212, another set of data is provided by the organization 213 and includes benefits and related information. The third set of data is any information that the company considers useful, and could be general company news, division or even department information, as shown in block 214.

It is possible that in many instances, the customized newsletter will be unique for a single individual, while in other instances the same customized newsletter would have a larger number of copies distributed. The newsletter integrates all issues covered in say the DVD or other media, shown in FIG. 11, including financial information and other relevant areas.

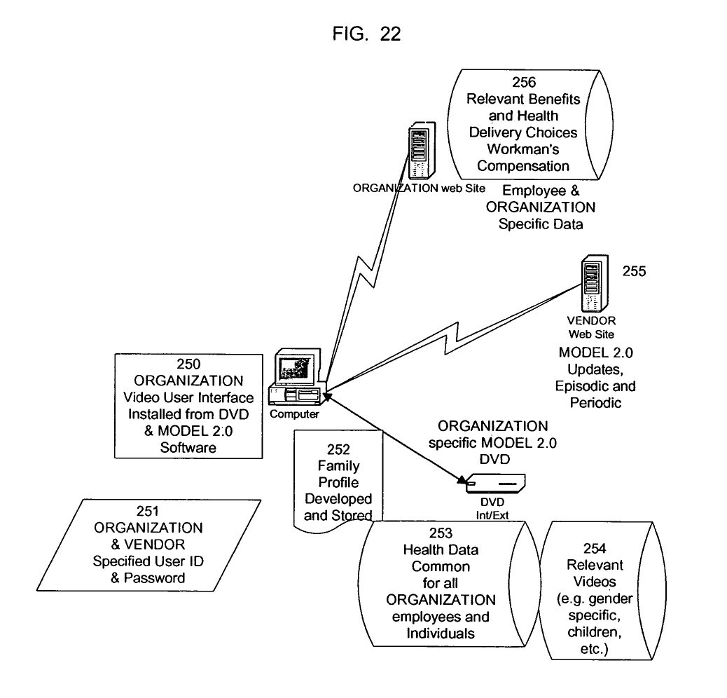

FIG. 22 shows an exemplary environment for MODEL 2.0 with the PC-DVD and Internet for data not related to the customized newsletter, other than the profile that is utilized also for the customized newsletter. Blocks 250, 251 and 252 are on the PC. The organization specific DVD includes the information shown in blocks 253 and 254. After the organization's customized video user interface and other MODEL 2.0 software are entered in block 250, online information integrated for the organization's and vendor's web sites have been entered in block 251, and the family profile are entered in block 252, the individual accesses the vendor web site for any software updates, video or other data updates as shown in block 255. Then, the organization's website is accessed for relevant benefits information consistent with the unique user id and password supplied by the organization. This is determined by organization specific criteria in block 256. The benefits information is integrated as described in FIG. 17. The DVD can be internal or external to the PC and retains the health data in block 253 and videos in block 254.

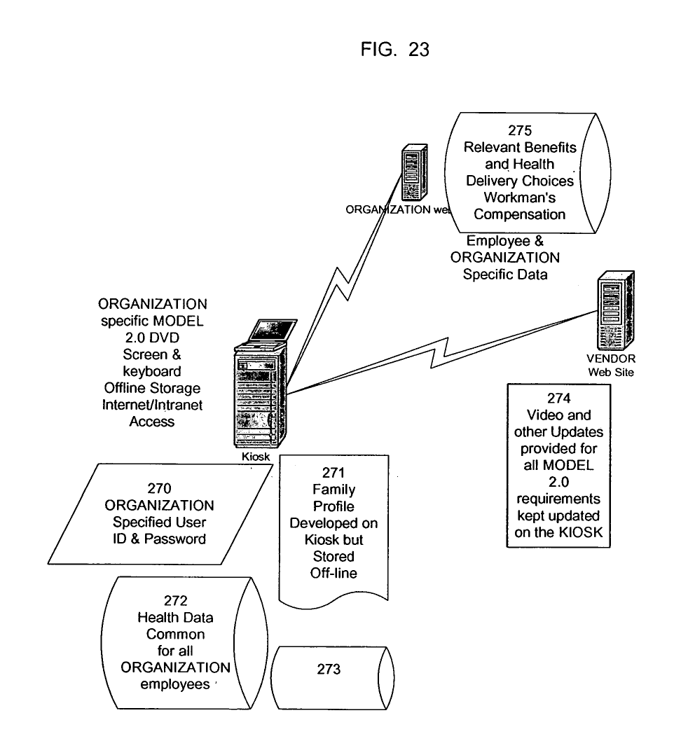

FIG. 23 shows a Kiosk configuration embodiment of the present invention which is internal to the organization (other than the information that is provided by the vendor) and is suited for employees who may not have an appropriate PC configuration at home. All the functions presented in FIG. 22 are also available in FIG. 23. The hardware/software/communications are available on the shop floor, the department, or any other organizational environment. The Kiosk integrates all MODEL 2.0 software accessed by the organization supplied user id, password combination. The information is described in blocks 270, 271,272 and 273, as an example. The Kiosk automatically updates all relevant information from the vendor website 274. The individual integrates all benefits information from the internal organization web site, also as shown in FIG. 22, but perhaps over a company LAN, WAN, or Intranet, or any other means. The profile is stored on off-line storage and is made available to the individual via the Kiosk.

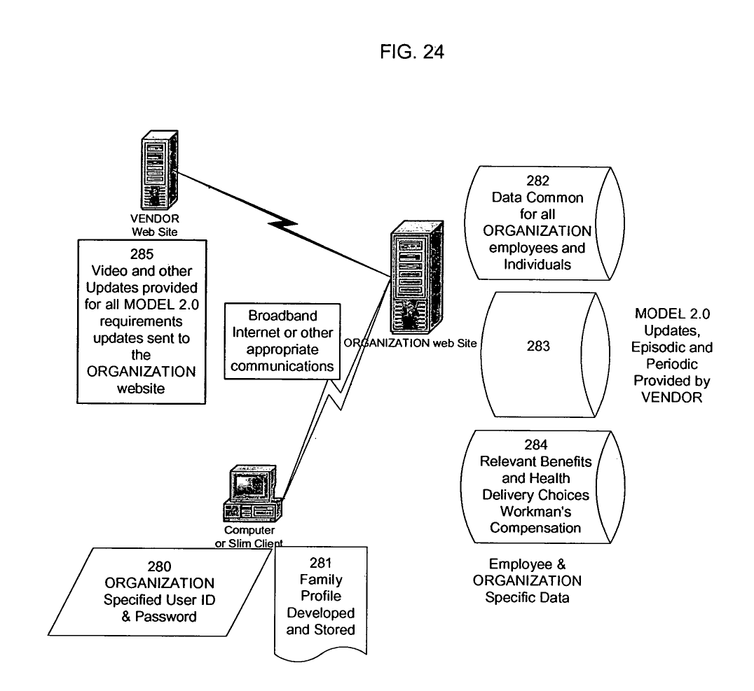

FIG. 24 shows a Web Centric embodiment of the present invention where all information (other than the customized newsletter) and the personal or family profiles are stored on the Web. The PC serves two main functions: as a communications device to the organization's website through the organization supplied user id and password combination in 280, and with attached off-line storage to store the profile generated for the individual's private use in block 281. All other functions are kept on the organization's web site and described as an example in blocks 282,283, and 284. In addition, the organization website is kept continually updated from the vendor website in block 285. All information contained in the DVD resides on the organization's website and any organization specific data and is kept evergreen from the vendor's website.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for optimizing health expenditure by an organization, the method comprising:
developing a Cohort-based personnel model for the organization;
determining lifecycle health costs based on the personnel model;
evaluating impact of a lifestyle program, a best health practices program, and an employee benefits program on the life cycle health costs for a first scenario; and
measuring a project evaluation criterion for the lifestyle, best health practices, and employee benefits programs.

2. The method of claim 1, further comprising optimizing investments by the organization for lifestyle, best health practices, and employee benefits program.

3. The method of claim 1, wherein developing a personnel model for the organization comprises developing an organizational Cohort population model including Cohorts based on age, occupation, seniority, and job hierarchy.

4. The method of claim 1, wherein developing the lifestyle health costs comprises determining a matrix including costs of benefits offered by the organization normalized by time value of money with each column representing present to future years.

5. The method of claim 1, further comprising:
determining lifecycle health costs based on the personnel model for a second scenario;
evaluating impact of a lifestyle program, a best health practices program, and an employee benefits program on the life cycle health costs for the second scenario; and
measuring a project evaluation criterion for the lifestyle, best health practices, and employee benefits programs for the second scenario.

6. The method of claim 1, wherein the developing a Cohort-based personnel model comprises developing a Cohort for one or more of employees, family members of employees, and retirees.

7. The method of claim 1, wherein the developing a Cohort-based personnel model comprises developing Cohorts for each category of age, gender, and seniority.

8. The method of claim 2, wherein the optimizing investments comprises selecting the highest measured project evaluation criterion for each lifestyle, best health practices, and employee benefits program.

9. The method of claim 2, wherein the optimizing investments comprises providing guidance on the overall allocation for health expenditures in the organization, and suggesting percentage of the allocation for prevention programs.

10. The method of claim 1, wherein the measured project evaluation criterion comprises of one or more of return on investment, internal rate of return, return on assets, and return on equity.

11. The method of claim 1, further comprising generating newsletters for assists individuals associated with the organization for enhancing quality of their lives in terms of both health and wealth.

12. The method of claim 1, further comprising integrating additional benefits from the lifestyle, best health practices, and employee benefits programs.

13. The method of claim 11, wherein the additional benefits include one or more of increased productivity, fewer sick days, reduced injury rate, and increased morale.

14. A method for integrating health and wealth of an individual, the method comprising:
developing a profile for the individual including current lifestyle, current health practices, and financial information of the individual;
determining a quality of life index for the individual based on wealth, best health practices and lifestyle of the individual, wherein the quality of life index includes both health and wealth information about the individual; and
measuring impacts of the profile, wealth, best health practices and lifestyle of the individual on the quality of life index.

15. The method of claim 14, further comprising making changes in the lifestyle, the current health practices, and the wealth information to improve the quality of life index.

16. The method of claim 14, wherein the individual is one or more of an employee, employee family member, and retiree associated with an organization.

17. The method of claim 14, further comprising optimizing the quality of life index responsive to selected lifestyle, best health practices, and employee benefits programs.

18. The method of claim 14, wherein the measuring impacts comprises measuring a project evaluation criterion for the lifestyle, best health practices, and wealth of the individual.

19. The method of claim 18, wherein the measured project evaluation criterion comprises of one or more of return on investment, internal rate of return, return on assets, and return on equity.

20. The method of claim 14, wherein the determining a quality of life index comprises calculating
QOLⁱ=w₀ⁱ(C′)+wₗⁱETWEALTH+w₂ⁱf(QALY₀ⁱ, LSⁱ, W(h)ⁱ) (19)
where, QOLⁱ is the Quality of Life index for individual i,
W₀ⁱ (C) is weighted consumption by the individual i on consumption other than for health investments,
W₁ⁱ is the weight associated with wealth creation,
ETWEALTH is the standard deferment of consumption that yields wealth in the next time period,
W₂ⁱ is a weight consistent with individual preferences attached to the individual's health, W (h)ⁱ is best health practices index for the individual i, and
QALY is a measure of good health for an individual consistent with their own preferences.

21. The method of claim 14, further comprising integrating health savings account with the wealth information.

22. The method of claim 14, wherein the developing a profile comprises integrating health information including gender, age, weight, state of current health, family predispositions to various diseases, a lifestyle questionnaire in terms of diet, nutrition, exercise levels, and a best health practices questionnaire on cost effective health screenings practiced consistent with age, gender, and family predispositions.

23. The method of claim 14, further comprising generating a customized newsletter for the individual based on the profile.

24. The method of claim 14, further comprising providing relevant sections of a DVD to the individual based on the profile.

25. The method of claim 14, further comprising electronically targeting information about lifestyle, current health practices, and financial information based on the profile.

26. A method for optimizing health expenditure by an organization, the method comprising:
determining a quality of life index for an individual associated with the organization based on wealth, best health practices and lifestyle of the individual;
measuring impacts of the profile, wealth, best health practices and lifestyle of the individual on the quality of life index;
selecting a best health practices program and a lifestyle program responsive to measured impacts;
determining lifecycle health costs based on the selected best health practices and the lifestyle programs;
evaluating impact of the selected lifestyle program, a best health practices program, and an employee benefits program on the life cycle health costs; and
measuring a project evaluation criterion for the lifestyle, best health practices, and employee benefits programs.

27. The method of claim 26, further comprising optimizing investments by the organization for lifestyle, best health practices, and employee benefits program.

28. The method of claim 26, further comprising integrating health savings account with the wealth information.

29. The method of claim 26, wherein the individual is one or more of an employee, employee family member, and retiree associated with the organization.

30. The method of claim 26, further comprising optimizing the quality of life index responsive to selected lifestyle, best health practices, and employee benefits programs.

31. A system for optimizing health expenditure for an organization comprising:
means for developing a Cohort-based personnel model for the organization;
means for determining lifecycle health costs based on the personnel model;
means for evaluating impact of a lifestyle program, a best health practices program, and an employee benefits program on the life cycle health costs for a first scenario; and
means for measuring a project evaluation criterion for the lifestyle, best health practices, and employee benefits programs.

32. The system of claim 31, further comprising means for optimizing investments by the organization for lifestyle, best health practices, and employee benefits program.

33. A system for integrating health and wealth of an individual comprising:
means for developing a profile for the individual including current lifestyle, current health practices, and financial information of the individual;
means for determining a quality of life index for the individual based on wealth, best health practices and lifestyle of the individual, wherein the quality of life index includes both health and wealth information about the individual; and
means for measuring impacts of the profile, wealth, best health practices and lifestyle of the individual on the quality of life index.

34. The system of claim 33, further comprising means for making changes in the lifestyle, the current health practices, and the

35. A system for optimizing health expenditure by an organization comprising:
means for determining a quality of life index for an individual associated with the organization based on wealth, best health practices and lifestyle of the individual;
means for measuring impacts of the profile, wealth, best health practices and lifestyle of the individual on the quality of life index;
means for selecting a best health practices program and a lifestyle program responsive to measured impacts;
means for determining lifecycle health costs based on the selected best health practices and the lifestyle programs;
means for evaluating impact of the selected lifestyle program, a best health practices program, and an employee benefits program on the life cycle health costs; and
means for measuring a project evaluation criterion for the lifestyle, best health practices, and employee benefits programs.

36. The system of claim 35, further comprising means for optimizing investments by the organization for lifestyle, best health practices, and employee benefits program.

37. The system of claim 35, further comprising means for integrating health savings account with the wealth information.
